(19) United States
(12) Patent Application Publication
(10) Pub. No.: US 2026/0132258 A1
(43) Pub. Date: May 14, 2026

(54) COMPOUND, COMPOSITION, SURFACE TREATMENT AGENT, METHOD FOR MANUFACTURING ARTICLE, AND ARTICLE

(71) Applicant: AGC Inc., Tokyo (JP)

(72) Inventors: Hironobu SAKAGUCHI, Tokyo (JP); Eiichiro ANRAKU, Tokyo (JP); Shiori KAWAKAMI, Tokyo (JP); Yasuhiro HIRATA, Tokyo (JP); Toyokazu ENTA, Tokyo (JP); Masayuki HARAGUCHI, Tokyo (JP)

(73) Assignee: AGC Inc., Tokyo (JP)

(21) Appl. No.: 19/443,192

(22) Filed: Jan. 8, 2026

Related U.S. Application Data
(63) Continuation of application No. PCT/JP2024/025028, filed on Jul. 10, 2024.

(30) Foreign Application Priority Data
Jul. 10, 2023 (JP) 2023-113041

(51) Int. Cl. C08G 77/06

(52) U.S. Cl. CPC C08G 77/06

(57) ABSTRACT

A new compound and a new composition useful as a surface treatment agent capable of forming a surface-treated layer having excellent light stability on a substrate, a surface treatment agent capable of forming such a surface-treated layer, a method for manufacturing an article including such a surface-treated layer, and an article are provided. A compound represented by Formula (1-1) or Formula (1-2).

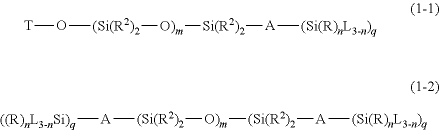

### INCORPORATION BY REFERENCE

This application is based upon and claims the benefit of priority from Japanese patent application No. 2023-113041, filed on Jul. 10, 2023, and PCT application PCT/JP2024/025028 filed on Jul. 10, 2024, the disclosure of which is incorporated herein in its entirety by reference.

### BACKGROUND

The present disclosure relates to a compound, a composition, a surface treatment agent, a method for manufacturing an article, and an article.

In recent years, there has been a demand for a technique for preventing the surface of an article from being stained with fingerprints, and a technique for facilitating the removal of dirt in order to improve properties of the article such as its appearance and visibility. As a specific method, a method for treating the surface of an article by using a surface treatment agent is known.

For example, Patent Literature 1 discloses a silane compound having a specific siloxane group used in such a surface treatment agent.
Patent Literature 1: International Patent Publication No. WO2023/017830

### SUMMARY

However, when we formed a surface-treated layer by using the silane compound disclosed in Patent Literature 1, we have found that it is necessary to further improve its light stability.

The present disclosure has been made in view of the above-described circumstances, and a problem to be solved by an embodiment according to the present invention is to provide a new compound and a new composition useful as a surface treatment agent capable of forming a surface-treated layer having excellent light stability on a substrate.

Another problem to be solved by an embodiment according to the present invention is to provide a surface treatment agent capable of forming a surface-treated layer having excellent light stability on a substrate.

Another problem to be solved by an embodiment according to the present invention is to provide a method for manufacturing an article including a surface-treated layer having excellent light stability and to provide such an article.

The present disclosure includes the below-shown aspects.

[1]

A compound represented by below-shown Formula (1-1) or Formula (1-2).

[2]

The compound according to Item [1], wherein the compound represented by Formula (1-1) is a compound represented by below-shown Formula (2), a compound represented by below-shown Formula (3), or a compound represented by below-shown Formula (4).

[3]

The compound according to Item [1], wherein m is an integer of 2 to 600.

[4]

The compound according to Item [1] or [3], wherein q is an integer of 1 to 4.

[5]

The compound according to Item [2], wherein m is an integer of 2 to 600.

[6]

The compound according to Item [2] or [5], wherein q is an integer of 1 to 4.

[7]

A composition comprising a compound according to any one of Items [1] to [6] and a liquid medium.

[8]

A surface treatment agent comprising a compound according to any one of Items [1] to [6].

[9]

A surface treatment agent comprising a compound according to any one of Items [1] to [6] and a liquid medium.

[10]

A method for manufacturing an article including a surface-treated layer formed on a substrate by performing a surface treatment on the substrate by using the surface treatment agent according to Item [8].

[11]

An article comprising a substrate, and a surface-treated layer disposed on the substrate, a surface of the surface-treated layer being treated with the surface treatment agent according to Item [8].

[12]

The article according to Item [11], wherein the article is an optical member.

[13]

The article according to Item [11] or [12], wherein the article is a display or a touch panel.

[14]

A method for manufacturing an article including a surface-treated layer formed on a substrate by performing a surface treatment on the substrate by using the surface treatment agent according to Item [9].

[15]

An article comprising a substrate, and a surface-treated layer disposed on the substrate, a surface of the surface-treated layer being treated with the surface treatment agent according to Item [9].

[16]

The article according to Item [15], wherein the article is an optical member.

[17]

The article according to Item [15] or [16], wherein the article is a display or a touch panel.

According to an embodiment of the present invention, it is possible to provide a new compound and a new composition useful as a surface treatment agent capable of forming a surface-treated layer having excellent light stability on a substrate.

According to an embodiment of the present invention, it is possible to provide a surface treatment agent capable of forming a surface-treated layer having excellent light stability on a substrate.

According to an embodiment of the present invention, it is possible to provide a method for manufacturing an article including a surface-treated layer having excellent light stability and to provide such an article.

The above and other objects, features and advantages of the present disclosure will become more fully understood from the detailed description given hereinbelow.

### DESCRIPTION OF EMBODIMENTS

A numerical value range specified by using “-” in the specification of the present disclosure includes numerical values before and after “-” as a lower limit value and an upper limit value, respectively, of the range. In numerical ranges described in a stepwise manner in the present specification, the upper or lower limit value of one numerical range may be replaced with the upper or lower limit value of another numerical range described in a stepwise manner. Further, in numerical ranges described in a stepwise manner in the present specification, the upper or lower limit value of a numerical range may be replaced with values shown in Examples.

In the specification of the present disclosure, the “surface-treated layer” refers to a layer that is formed on the surface of a substrate by a surface treatment.

In this specification, “Me” represents a methyl group.

In this specification, when a compound or a group is represented by a specific formula (X), the compound or the group represented by this formula (X) may be expressed as a compound (X) or a compound X, and a group (X) or a group X, respectively.

The bonding direction of a divalent group shown in the specification of the present disclosure is not limited to any particular directions unless otherwise specified. For example, when Y is —COO— in a compound represented by a formula “X—Y—Z”, Y may be —CO—O— or —O—CO—. Further, the aforementioned compound may be “X—CO—O—Z” or “X—O—CO—Z”.

### [Compound]

A compound according to the present disclosure is a compound represented by Formula (1-1) (which will be described later) or a compound represented by Formula (1-2) (which will be described later). In this specification, the compound according to the present disclosure means at least one of a compound represented by Formula (1-1) and a compound represented by Formula (1-2).

The compound according to the present disclosure has a linking group having an alicyclic structure which may have a heteroatom at a specific place. Although the reason for this feature is not clear, it is possible to, by using such a compound according to the present disclosure, form a surface-treated layer having excellent light stability.

A compound according to the present disclosure will be described hereinafter in detail.

### <Compound Represented by Formula (1-1)>

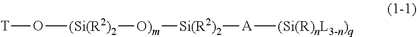

In Formula (1-1),
T is (R¹)₃Si—, a monovalent cyclic polysiloxane residue, or a monovalent cage-like polysiloxane residue,
R¹ is each independently a hydrocarbon group or a trialkylsilyloxy group,
R² is each independently a hydrocarbon group or a trialkylsilyloxy group,
A is a linking group having a valence of (q+1) and having an alicyclic structure which may have a heteroatom,
R is each independently a hydrocarbon group,
L is each independently a hydrolyzable group, a group having a hydrolyzable group, or a hydroxyl group,
m is a number of 0 or greater,
n is each independently an integer of 0 to 2, and
q is an integer of 1 or greater.

In Formula (1-1), T is (R¹)₃Si—, a monovalent cyclic polysiloxane residue, or a monovalent cage-like polysiloxane residue.

Examples of the hydrocarbon group represented by R¹ include an aliphatic hydrocarbon group and an aromatic hydrocarbon group. In particular, the hydrocarbon group is preferably an aliphatic hydrocarbon group and more preferably an alkyl group. The alkyl group may be any of a linear alkyl group, a branched alkyl group, or a cyclic alkyl group, and is preferably a linear alkyl group. The number of carbon atoms of the alkyl group is preferably 1 to 10, more preferably 1 to 6, and still more preferably 1 to 4. The hydrocarbon group represented by R¹ is more preferably a methyl group, an ethyl group, an n-propyl group, or an n-butyl group, and particularly preferably a methyl group.

The alkyl group contained in the trialkylsilyloxy group represented by R¹ may be any of a linear alkyl group, a branched alkyl group, or a cyclic alkyl group, and is preferably a linear alkyl group. The number of carbon atoms of the alkyl group contained in the trialkylsilyloxy group represented by R¹ is preferably 1 to 10, more preferably 1 to 6, and still more preferably 1 to 4. The alkyl group contained in the trialkylsilyloxy group represented by R¹ is more preferably a methyl group, an ethyl group, an n-propyl group, or an n-butyl group, and still more preferably a methyl group.

The plurality of R¹ may be the same as each other or different from each other, and are preferably the same as each other in view of the ease of the manufacturing.

In particular, in order to improve the water repellency of the surface-treated layer, R¹ is preferably a linear alkyl group or a trialkylsilyloxy group in which an alkyl group is a linear alkyl group, more preferably a methyl group, an ethyl group, an n-propyl group, an n-butyl group, or a trimethylsilyloxy group, and still more preferably a methyl group or a trimethylsilyloxy group.

Examples of the group represented by (R¹)₃Si— include a methyldiethylsilyl group, a methylethylpropylsilyl group, a methylethylbutylsilyl group, a methyldipropylsilyl group, a methylpropylbutylsilyl group, a methyldibutylsilyl group, a dimethylethylsilyl group, a dimethylpropylsilyl group, a dimethylbutylsilyl group, a trimethylsilyl group, a triethylsilyl group, a tri-n-propylsilyl group, a tri-isopropylsilyl group, a tris (trimethylsilyloxy) silyl group, a methylbis (trimethylsilyloxy) silyl group, and a dimethyl (trimethylsilyloxy) silyl group.

The monovalent cyclic polysiloxane residue is preferably a group represented by Formula (T1).

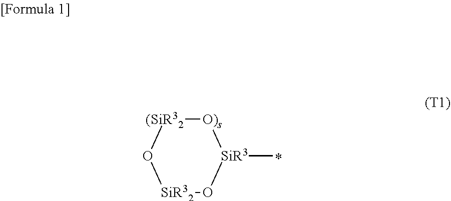

In Formula (Ti):
R³ is each independently a hydrocarbon group, a hydrocarbon group having a substituent, or a group represented by —O—SiR⁵¹₃,
s is an integer of 1 to 4,
R⁵¹ is each independently a hydrocarbon group or a trialkylsilyloxy group, and
* indicates a bonding position.

Examples of the hydrocarbon group represented by R³ include an aliphatic hydrocarbon group and an aromatic hydrocarbon group. In particular, the hydrocarbon group is preferably an aliphatic hydrocarbon group and more preferably an alkyl group.

The alkyl group in an aspect of the hydrocarbon group represented by R³ may be any of a linear alkyl group, a branched alkyl group, or a cyclic alkyl group, and is preferably a linear alkyl group. The number of carbon atoms of the alkyl group is preferably 1 to 10, more preferably 1 to 8, and still more preferably 1 to 4. Specifically, the alkyl group represented by R³ is preferably a methyl group, an ethyl group, an n-propyl group, an n-butyl group, an isobutyl group, or a heptyl group, and more preferably a methyl group.

Examples of the hydrocarbon group contained in the hydrocarbon group having a substituent represented by R³ include an aliphatic hydrocarbon group and an aromatic hydrocarbon group. In particular, the hydrocarbon group is preferably an aliphatic hydrocarbon group and more preferably an alkyl group. The alkyl group may be any of a linear alkyl group, a branched alkyl group, or a cyclic alkyl group, and is preferably a linear alkyl group. The number of carbon atoms of the alkyl group contained in the substitution alkyl group is preferably 1 to 10, more preferably 1 to 8, and still more preferably 2 to 4.

Examples of the substituent in the hydrocarbon group having the substituent represented by R³ include a halogen atom, a hydroxyl group, an alkoxy group, a trialkylsilyl ether group, a trialkylsilyl group, an amino group, a nitro group, a cyano group, a sulfonyl group, a trifluoromethyl group, and a group represented by —SiR⁵²₃. R¹² is each independently a hydrocarbon group or a trialkylsilyloxy group.

Examples of the hydrocarbon group represented by R⁵² include hydrocarbon groups similar to those represented by R³.

The alkyl group contained in the trialkylsilyloxy group represented by R⁵² may be any of a linear alkyl group, a branched alkyl group, or a cyclic alkyl group, and is preferably a linear alkyl group. The number of carbon atoms of the alkyl group is preferably 1 to 10, more preferably 1 to 8, still more preferably 1 to 4, and particularly preferably 1. The three alkyl groups contained in the trialkylsilyloxy group may be the same as each other or different from each other.

The three R⁵² may be the same as each other or different from each other, and are preferably the same as each other in view of the ease of the manufacturing.

When R³ is a group represented by —O—SiR⁵¹₃, R⁵¹ is each independently a hydrocarbon group or a trialkylsilyloxy group. Examples of the hydrocarbon group represented by R⁵¹ include hydrocarbon groups similar to those represented by R³. Examples of the trialkylsilyloxy group represented by R⁵¹ include trialkylsilyloxy groups similar to those represented by R⁵².

The plurality of R³ may be the same as each other or different from each other, and are preferably the same as each other in view of the ease of the manufacturing.

Examples of monovalent cyclic polysiloxane residues include groups shown below. * indicates a bonding position.

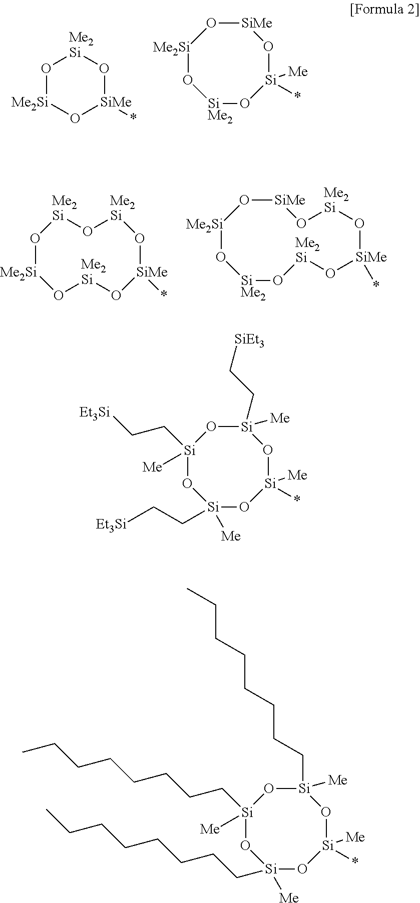

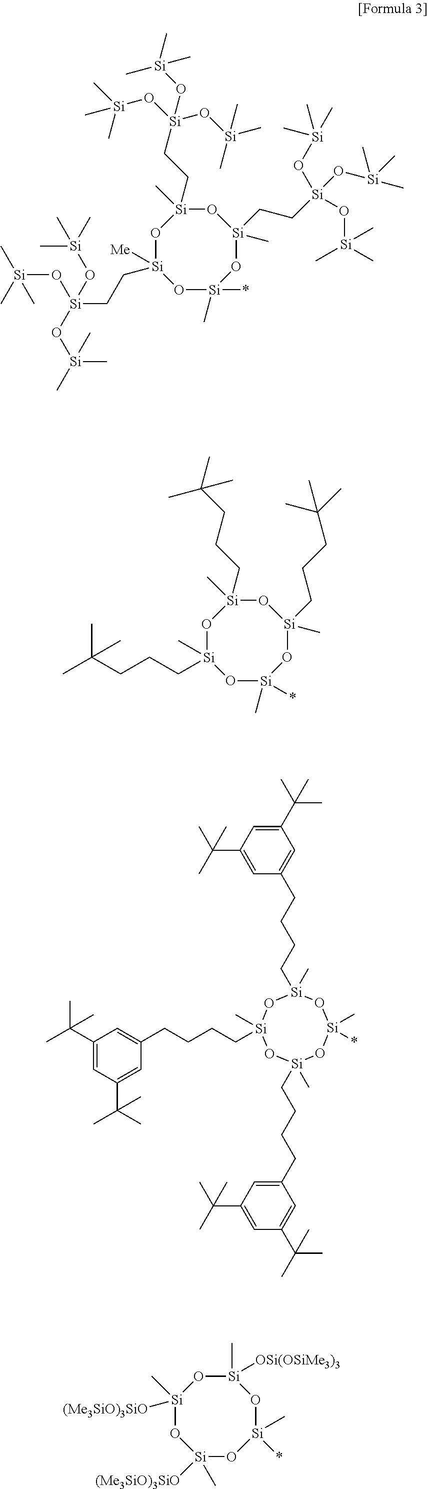

The monovalent cage-like polysiloxane residue is preferably a group represented by Formula (T2).

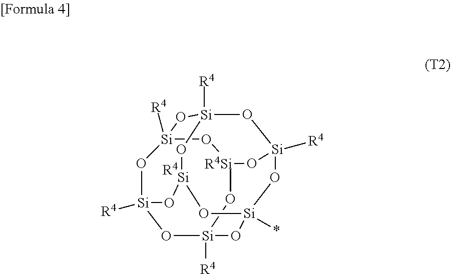

In Formula (T2),
R⁴ is each independently a hydrocarbon group or a trialkylsilyloxy group, and
* indicates a bonding position.

Examples of the hydrocarbon group represented by R⁴ include an aliphatic hydrocarbon group and an aromatic hydrocarbon group. In particular, the hydrocarbon group is preferably an aliphatic hydrocarbon group and more preferably an alkyl group. The alkyl group may be any of a linear alkyl group, a branched alkyl group, or a cyclic alkyl group, and is preferably a linear alkyl group or a branched alkyl group. The number of carbon atoms of the alkyl group is preferably 1 to 10, more preferably 1 to 6, and still more preferably 1 to 4. The hydrocarbon group represented by R⁴ is more preferably a methyl group, an ethyl group, an n-propyl group, an n-butyl group, or an isobutyl group, and particularly preferably an isobutyl group.

The alkyl group contained in the trialkylsilyloxy group represented by R⁴ may be any of a linear alkyl group, a branched alkyl group, or a cyclic alkyl group, and is preferably a linear alkyl group. The number of carbon atoms of the alkyl group contained in the trialkylsilyloxy group represented by R⁴ is preferably 1 to 10, more preferably 1 to 6, and still more preferably 1 to 4. The hydrocarbon group represented by R¹ is more preferably a methyl group, an ethyl group, an n-propyl group, or an n-butyl group, and still more preferably a methyl group.

The plurality of R⁴ may be the same as each other or different from each other, and are preferably the same as each other in view of the ease of the manufacturing.

Examples of the monovalent cage-like polysiloxane residue include groups shown below. * indicates a bonding position.

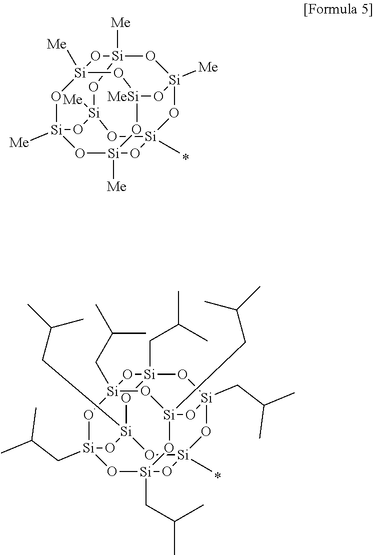

In Formula (1-1), R² is each independently a hydrocarbon group or a trialkylsilyloxy group. R² is preferably each independently a hydrocarbon group.

The number of carbon atoms of R² is preferably 1 to 10, more preferably 1 to 6, and still more preferably 1 to 4.

When R² is a hydrocarbon group, the hydrocarbon group is preferably an aliphatic hydrocarbon group and more preferably an alkyl group. The alkyl group may be any of a linear alkyl group, a branched alkyl group, or a cyclic alkyl group, and is preferably a linear alkyl group. The number of carbon atoms of the alkyl group is preferably 1 to 10, more preferably 1 to 6, and still more preferably 1 to 4. The hydrocarbon group is still more preferably a methyl group, an ethyl group, an n-propyl group, or an n-butyl group, and particularly preferably a methyl group.

When R² is a trialkylsilyloxy group, the alkyl group contained in the trialkylsilyloxy group may be any of a linear alkyl group, a branched alkyl group, or a cyclic alkyl group, and is preferably a linear alkyl group. The number of carbon atoms of the alkyl group contained in the trialkylsilyloxy group is preferably 1 to 10, more preferably 1 to 6, and still more preferably 1 to 4. The alkyl group contained in the trialkylsilyloxy group is more preferably a methyl group, an ethyl group, an n-propyl group, or an n-butyl group, and still more preferably a methyl group.

In Formula (1-1), R is each independently a hydrocarbon group.

Examples of the hydrocarbon group represented by R include the hydrocarbon group represented by R².

In Formula (1-1), L is each independently a hydrolyzable group, a group having a hydrolyzable group, or a hydroxyl group.

The hydrolyzable group is a group which becomes a hydroxyl group through a hydrolysis reaction. That is, a hydrolyzable silyl group represented by Si-L becomes a silanol group represented by Si—OH through a hydrolysis reaction. Such silanol groups further react with each other and form a Si—O—Si bond. Further, such a silanol group has a dehydration condensation reaction with a silanol group derived from an oxide present on the surface of the substrate, and thereby can form a Si—O—Si bond.

Examples of hydrolyzable groups include an alkoxy group, an aryloxy group, a halogen atom, an acyl group, an acyloxy group, and an isocyanato group (—NCO). The alkoxy group is preferably an alkoxy group having a number of carbon atoms of 1 to 4. The aryloxy group is preferably an aryloxy group having a number of carbon atoms of 3 to 10. Note that the aryl group of the aryloxy group includes a heteroaryl group. The halogen atom is preferably a chlorine atom. The acyl group is preferably an acyl group having a number of carbon atoms of 1 to 6. The acyloxy group is preferably an acyloxy group having a number of carbon atoms of 1 to 6.

Examples of groups having a hydrolyzable group include groups having a hydrolyzable group shown above as examples. The group having a hydrolyzable group is preferably —O-L^{A}-L^{B}. L^{A} is an alkylene group, and L^{B} is a hydrolyzable group. The number of carbon atoms of the alkylene group is preferably 1 to 10. The hydrolyzable group represented by L^{B} is synonymous with the above-described hydrolyzable group represented by L, and its preferred forms are also the same as those described above.

In particular, L is preferably an alkoxy group having a number of carbon atoms of 1 to 4 or a halogen atom in view of the ease of the manufacturing of the compound. L is preferably an alkoxy group having a number of carbon atoms of 1 to 4 and more preferably an ethoxy group or a methoxy group in view of the fact that outgassing during the application is small and because the storage stability of the compound becomes more excellent.

In Formula (1-1), m is a number of 0 or greater. m may be 1 or greater.
m is preferably 2 to 600, more preferably 3 to 500, still more preferably 9 to 50, particularly preferably 11 to 30, and most preferably 11 to 25.

In Formula (1-1) or Formula (1-2), the number m of repetitive units represented by “(Si(R²)₂—O)” is an average value calculated from data obtained by measuring the compound by nuclear magnetic resonance (NMR).

In Formula (1-1), n is each independently an integer of 0 to 2.
n is preferably 0 or 1 and more preferably 0. The presence of a plurality of L makes the adhesive property of the surface-treated layer for the substrate stronger.

When n is 1 or smaller, the plurality of L present in one molecule may be the same as each other or different from each other. The plurality of L are preferably the same as each other in view of the availability of raw materials and the ease of the manufacturing of the compound. When n is 2, the plurality of R present in one molecule may be the same as each other or different from each other. The plurality of R are preferably the same as each other in view of the availability of raw materials and the ease of the manufacturing of the compound.

In Formula (1-1), q is an integer of 1 or greater.
q is preferably an integer of 1 to 15, more preferably an integer of 1 to 6, still more preferably an integer of 1 to 4, and particularly preferably an integer of 1 to 3 because the light stability of the surface-treated layer becomes more excellent.

When q is an integer of 2 or greater, the plurality of [Si(R)ₙL₃₋ₙ] may be the same as each other or different from each other. The plurality of [Si(R)ₙL₃₋ₙ] are preferably the same as each other in view of the availability of raw materials and the ease of the manufacturing of the compound.

In Formula (1-1), A is a linking group having a valence of (q+1) and having an alicyclic structure which may have a heteroatom.

Hereinafter, the ring constituting an alicyclic structure which may have a heteroatom, contained in the compound according to the present disclosure is also referred to as the “specific ring structure”.

The specific ring structure which A has may be any of a monocyclic ring, a condensed polycyclic ring, a bridged ring, a spiro ring, and an assembled polycyclic ring as long as the ring is not aromatic. Further, the atoms constituting the ring (hereinafter also referred to as the ring constituent atoms) may be a carbocyclic ring consisting solely of carbon atoms or a heterocyclic ring consisting of a heteroatom(s) having a valence of 2 or greater and a carbon atom(s). Further, the bond between the ring constituent atoms may be a single bond, or may be a multiple bond as long as the ring is non-aromatic.

The monocyclic ring is preferably a 4 to 8 membered ring, and more preferably a 5 membered ring or a 6 membered ring.

The condensed polycyclic ring is preferably a condensed polycyclic ring in which two or more 4 to 8 membered rings are condensed, and more preferably a condensed polycyclic ring in which 2 to 4 rings selected from 5 membered rings and 6 membered rings are bonded, or a condensed polycyclic ring in which one or two rings selected from 5 membered rings and 6 membered rings, and one 4 membered ring are bonded.

The bridged ring is preferably a bridged ring in which a 5 membered ring or a 6 membered ring is the largest ring, and more preferably an adamantane ring.

The spiro ring is preferably a spiro ring consisting of two 4 to 6 membered rings.

The assembled polycyclic ring is preferably an assembled polycyclic ring in which 2 or 3 rings selected from 5 membered rings and 6 membered rings are bonded through a single bond.

The heteroatom constituting the specific ring structure is preferably a nitrogen atom, an oxygen atom, a sulfur atom, or a silicon atom, and more preferably a nitrogen atom or an oxygen atom. The number of heteroatoms constituting the specific ring structure is preferably 3 or smaller. Further, when the number of heteroatoms constituting the specific ring structure is two or more, these heteroatoms may be the same as each other or different from each other.

The specific ring structure is preferably one type of ring selected from the group consisting of a 3 to 8 membered aliphatic ring, a 3 to 8 membered hetero-aliphatic ring, a condensed ring in which 2 to 4 of these rings are condensed, a bridged ring in which a 5 membered ring or a 6 membered ring is the largest ring, and an assembled polycyclic ring having two or more of these rings in which they are connected by a single bond in view of the ease of the manufacturing of the compound and because the light stability of the surface-treated layer becomes more excellent.

The preferred ring is a 5 membered or 6 membered aliphatic ring, a 5 membered or 6 membered heterocycle having a nitrogen atom or an oxygen atom, a condensed ring in which 2 to 4 carbon rings of 5 membered or 6 membered rings are condensed, a bridged ring in which a 5 membered ring or a 6 membered ring is the largest ring, or a condensed ring of a bridged ring in which a 5 membered ring or a 6 membered ring is the largest ring and a 5 membered heterocycle.

Examples of the specific ring structure include rings shown below, a 1,3-cyclohexadiene ring, a 1,4-cyclohexadiene ring, a cyclopropane ring, a norbornene ring, a norbornadiene ring, a morpholine ring, an aziridine ring, a pyran ring, and an indene ring. Note that rings having an oxo group (═O) are also shown below.

R in the condensed rings shown below is a hydrogen atom or a methyl group.

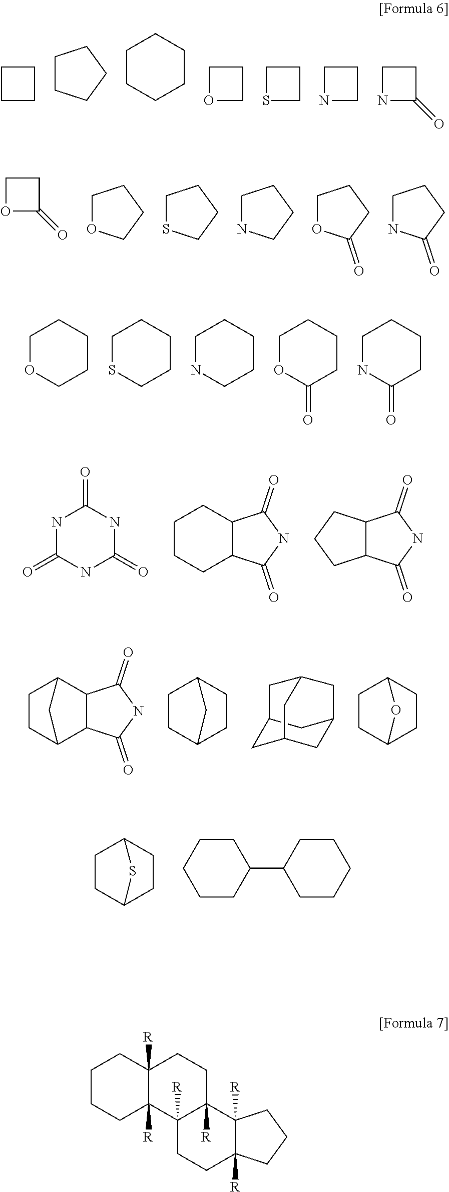

In Formula (1-1), A may consist solely of a specific ring structure, or may be a group in which at least one specific ring structure and at least one linking group having a valence of 2 or greater are combined.

The linking having a valence of 2 or greater which A may have may be any group which does not impair the effects of the present disclosure, and examples include an alkylene group which may have an etheric oxygen atom or a divalent organopolysiloxane residue, a carbon atom, a nitrogen atom, a silicon atom, and an organopolysiloxane residue having a valence of 2 to 8, as well as [-L₁-L²-L³-] in Formula (2), [-L⁴-L⁵-(L⁶-*)ᵣ] in Formula (3), and [-L⁷-L⁸-L⁹-L¹⁰-(L¹¹-*)ₛ] in Formula (4) (which will be described later). Note that * indicates a position of a bond with [Si(R)ₙL₃₋ₙ].

The compound represented by Formula (1-1) is preferably a compound represented by Formula (2), a compound represented by Formula (3), or a compound represented by Formula (4).

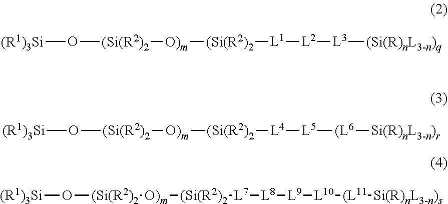

In Formula (2), L¹ is a single bond or a divalent linking group; L² is a divalent alicyclic group which may have a heteroatom; and L³ is a linking group having a valence of (q+1).

In Formula (3), L⁴ is a single bond or a divalent linking group; L⁵ is an alicyclic group which may have a heteroatom having a valence of (r+1); L⁶ is each independently a single bond or a divalent linking group; and r is an integer of 1 or greater.

In Formula (4), L⁷ and L⁹ are each independently a single bond or a divalent linking group; L⁸ is a divalent alicyclic group which may have a heteroatom; L¹⁰ is an alicyclic group which may have a heteroatom having a valence of (s+1); L¹¹ is each independently a single bond or a divalent linking group; and s is an integer of 1 or greater.

In particular, it is more preferably a compound represented by Formula (2) or a compound represented by Formula (4).

Each of a compound represented by Formula (2), a compound represented by Formula (3), and a compound represented by Formula (4) will be described hereinafter.

The compound represented by Formula (1-1) may be a compound represented by the above-shown Formula (2).

In Formula (2), L¹ is a single bond or a divalent linking group.

Examples of divalent linking groups include a divalent hydrocarbon group, —O—, —S—, —SO₂—, —N(R^{d})—, —C(O)—, —Si(R^{a})₂—, and a group in which two or more of these groups are combined.

However, the end of the —Si(R²)₂— side of L¹ is not —O—Si(R^{a})₂—.

Further, the divalent linking group, which is L¹, is preferably a divalent group other than the divalent alicyclic group which may have a heteroatom.

The aforementioned divalent hydrocarbon group may be a divalent linear or branched saturated hydrocarbon group, an alkenylene group, or an alkynylene group. Examples of divalent linear or branched saturated hydrocarbon groups include an alkylene group. The number of carbon atoms of the alkylene group is preferably 1 to 30, more preferably 1 to 20, still more preferably 4 to 20, and particularly preferably 5 to 15. The number of carbon atoms of the alkenylene group is preferably 2 to 20, and the number of carbon atoms of the alkynylene group is preferably 2 to 20.

The aforementioned R^{a} is an alkyl group (preferably having a number of carbon atoms of 1 to 10). The aforementioned R^{d} is a hydrogen atom or an alkyl group (preferably having a number of carbon atoms of 1 to 10).

Note that examples of groups in which two or more of the aforementioned groups are combined include —C(O)O—, —C(O)S—, —C(O)N(R^{d})—, —N(R^{d})C(O)N(R^{d})—, —N(R^{d})C(O)O—, —SO₂N(R^{d})—, an alkylene group having —C(O)N(R^{d})—, an alkylene group having —OC(O)N(R^{d})—, an alkylene group having an etheric oxygen atom, an alkylene group having —S—, an alkylene group having —C(O)O—, an alkylene group having —C(O)S—, an alkylene group having —N(R^{d})—, an alkylene group having —N(R^{d})C(O)N(R^{d})—, an alkylene group having —SO₂N(R^{d})—, and alkylene group-C(O)N(R^{d})-alkylene group.

In particular, L¹ is preferably a single bond, a divalent alkylene group, —O—, —S—, —SO₂—, —N(R^{d})—, —C(O)—, —Si(R^{a})₂—, —C(O)O—, —C(O)S—, —C(O)N(R^{d})—, —N(R^{d})C(O)N(R^{d})—, —N(R^{d})C(O)O—, —SO₂N(R^{d})—, an alkylene group having —C(O)N(R^{d})—, an alkylene group having —OC(O)N(R^{d})—, an alkylene group having an etheric oxygen atom, an alkylene group having —S—, an alkylene group having —C(O)O—, an alkylene group having —C(O)S—, an alkylene group having —N(R^{d})—, an alkylene group having —N(R^{d})C(O)N(R^{d})—, an alkylene group having —SO₂N(R^{d})—, or alkylene group-C(O)N(R^{d})-alkylene group, more preferably a single bond, an alkylene group, —C(O)O—, an alkylene group having —C(O)N(R^{d})—, an alkylene group having —OC(O)N(R^{d})—, an alkylene group having an etheric oxygen atom, an alkylene group having —S—, an alkylene group having —C(O)O—, an alkylene group having —C(O)S—, an alkylene group having —N(R^{d})—, an alkylene group having —N(R^{d})C(O)N(R^{d})—, or alkylene group-C(O)N(R^{d})-alkylene group, and still more preferably a single bond, an alkylene group, an alkylene group having an etheric oxygen atom, or alkylene group-C(O)N(R^{d})-alkylene group.

In Formula (2), L² is a divalent alicyclic group which may have a heteroatom.

The divalent alicyclic group which may have a heteroatom is a group consisting of the above-described specific ring structure, and its preferred forms are also the same as those described above.

In particular, L² preferably contains a ring selected from the group consisting of a cyclopentane ring, a cyclohexane ring, an adamantane ring, a piperidine ring, and condensed rings shown below, and more preferably contains an adamantane ring.

The definition of R is the same as that described above.

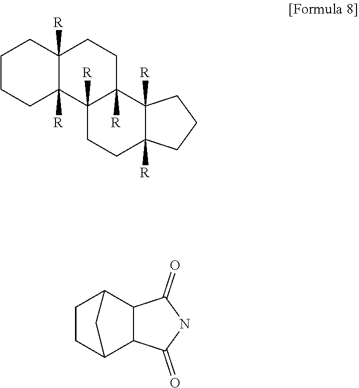

A bond that does not constitute the ring of atoms constituting the specific ring structure is a bond that is bonded to L¹ or L³. When there is a remaining bond(s), the remaining bond(s) is bonded to a hydrogen atom or a substituent. Examples of such substituents include a halogen atom, an alkyl group (which may contain an etheric oxygen atom between carbon atoms), an alkenyl group, an allyl group, an alkoxy group, and an oxo group (═O). The remaining bond(s) is preferably bonded to a hydrogen atom or an alkyl group, and more preferably bonded to a hydrogen atom. The number of carbon atoms of the alkyl group is preferably 1 to 5, more preferably 1 to 3, and still more preferably 1.

In Formula (2), L³ is a linking group having a valence of (q+1).

L³ is preferably a group (3-1A) or a group (3-1B), and more preferably a group (3-1A).

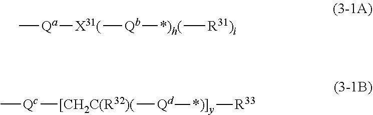

Note that in Formulas (3-1A) and (3-1B), * indicates a position of a bond with [—Si(R)ₙL₃₋ₙ].

In Formula (3-1A), Q^{a} is a single bond or a divalent linking group.

Note that in the case where X³¹ is an alkylene group, the end of Q^{a} at the side bonded to X³¹ is not an alkylene group.

The definition of the divalent linking group is synonymous with the definition described above for L¹.

In particular, Q^{a} is preferably a divalent alkylene group, —O—, —S—, —SO₂—, —N(R^{d})—, —C(O)—, —Si(R^{a})₂—, —C(O)O—, —C(O)S—, —C(O)N(R^{d})—, —N(R^{d})C(O)N(R^{d})—, —N(R^{d})C(O)O—, —SO₂N(R^{d})—, an alkylene group having —C(O)N(R^{d})—, an alkylene group having —OC(O)N(R^{d})—, an alkylene group having an etheric oxygen atom, an alkylene group having —S—, an alkylene group having —C(O)O—, an alkylene group having —C(O)S—, an alkylene group having —N(R^{d})—, an alkylene group having —N(R^{d})C(O)N(R^{d})—, an alkylene group having —SO₂N(R^{d})—, or alkylene group-C(O)N(R^{d})-alkylene group, more preferably an alkylene group, —C(O)O—, an alkylene group having —C(O)N(R^{d})—, an alkylene group having —OC(O)N(R^{d})—, an alkylene group having an etheric oxygen atom, an alkylene group having —S—, an alkylene group having —C(O)O—, an alkylene group having —C(O)S—, an alkylene group having —N(R^{d})—, an alkylene group having —N(R^{d})C(O)N(R^{d})—, or alkylene group-C(O)N(R^{d})-alkylene group, and still more preferably an alkylene group, an alkylene group having —C(O)N(R^{d})—, or alkylene group-C(O)N(R^{d})-alkylene group. Definitions and preferred forms of R^{a} and R^{d} are the same as those described above.

In Formula (3-1A), X³¹ is an alkylene group, a nitrogen atom, a carbon atom, a silicon atom, or an organopolysiloxane residue having a valence of 2 to 8.

Note that the alkylene group may have —O—, a divalent organopolysiloxane residue, or a dialkylsilylene group. The alkylene group may have a plurality of groups selected from the group consisting of —O—, a divalent organopolysiloxane residue, and a dialkylsilylene group.

The number of carbon atoms of the alkylene group represented by X³¹ is preferably 1 to 20 and more preferably 1 to 10.

Examples of organopolysiloxane residues having a valence of 2 to 8 include a divalent organopolysiloxane residue and an organopolysiloxane residue having a valence of (w+1) (which will be described later).

In particular, X³¹ is preferably a nitrogen atom, a carbon atom, a silicon atom, or an organopolysiloxane residue having a valence of 4 to 8, and more preferably a carbon atom in order to improve the light stability of the surface-treated layer.

In Formula (3-1A), Q^{b} is a single bond or a divalent linking group.

The definition of the divalent linking group is synonymous with the definition of the above-described Q^{a}.

When there are two or more Q^{b}, the two or more Q^{b} may be the same as each other or different from each other.

In particular, Q^{b} is preferably an alkylene group which may have an etheric oxygen atom. The number of carbon atoms of the alkylene group is preferably 1 to 30, more preferably 1 to 20, still more preferably 2 to 20, and may be 2 to 10, 2 to 6, or 2 to 5. For example, the number of carbon atoms is 2, 3, 8, 9 or 11. Further, the aforementioned number of carbon atoms may be 1 to 10.

In Formula (3-1A), R³¹ is a hydrogen atom, a hydroxyl group, or an alkyl group.

When there are two or more R³¹, the two or more (—R³¹) may be the same as each other or different from each other.

The number of carbon atoms of the alkyl group is preferably 1 to 5, more preferably 1 to 3, and still more preferably 1.

When X³¹ is a single bond or an alkylene group, h is 1 and i is 0,
when X³¹ is a nitrogen atom, h is an integer of 1 or 2 and i is an integer of 0 or 1, where h+i=2,
when X³¹ is a carbon atom or a silicon atom, h is an integer of 1 to 3 and i is an integer of 0 to 2, where h+i=3, and
when X³¹ is an organopolysiloxane residue having a valence of 2 to 8, h is an integer of 1 to 7 and i is an integer of 0 to 6, where h+i=1 to 7.

In particular, i is preferably 0 or 1 in order to improve the light stability of the surface-treated layer.

Further, h is preferably 2 or 3 in order to improve the light stability of the surface-treated layer.

In Formula (3-1B), Q^{c} is a single bond or a divalent linking group.

The definition of the divalent linking group is synonymous with the definition described above for L¹.

In Formula (3-1B), R³² is a hydrogen atom or an alkyl group having a number of carbon atoms of 1 to 10, and is preferably a hydrogen atom in view of the ease of the manufacturing of the compound.

The alkyl group is preferably a methyl group.

In Formula (3-1B), Q^{d} is a single bond or an alkylene group. The number of carbon atoms of the alkylene group is preferably 1 to 30 more preferably 1 to 20, and may be 1 to 10 or 1 to 6. Further, the aforementioned number of carbon atoms may be 2 to 20.

In Formula (3-1B), R³³ is a hydrogen atom or a halogen atom, and is preferably a hydrogen atom in view of the ease of the manufacturing of the compound.
y is an integer of 1 to 10, and preferably an integer of 1 to 6.

The two or more [CH₂C(R³²)(-Q^{d}-*)] may be the same as each other or different from each other.

The group represented by -L³-(Si(R)ₙL₃₋ₙ)_{q}, in which L³ is the group (3-1A), is preferably one of groups (3-1A-1) to (3-1A-7).

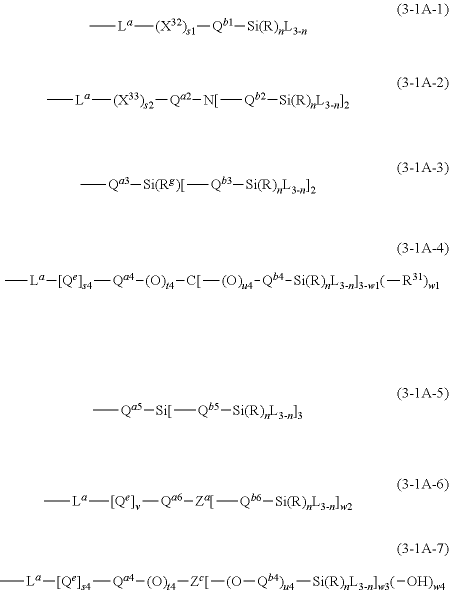

Note that definitions and preferred forms of R, L and n in Formulas (3-1A-1) to (3-1A-7) are the same as those described above.

In particular, the group (3-1A) is preferably a group obtained by removing Si(R)ₙL₃₋ₙ from the group (3-1A-1) or the group (3-1A-4), and more preferably a group obtained by removing Si(R)ₙL₃₋ₙ from the group (3-1A-4).

In Formulas (3-1A-1), (3-1A-2), (3-1A-4), (3-1A-6) and (3-1A-7), L^{a} is a single bond or an alkylene group.

The aforementioned alkylene group is, for example, synonymous with the alkylene group shown above as an example of the divalent linking group represented by L¹, and its preferred forms are also the same as those described above.

In the group (3-1A-1), X³² is —O—, —S—, —N(R^{d})—, —C(O)—, —C(O)O—, —C(O)S—, —SO₂N(R^{d})—, —N(R^{d})C(O)N(R^{d})—, —OC(O)N(R^{d})—, or —C(O)N(R^{d})—
(note that N in the formula is bonded to Q^{b1}).

Definitions and preferred forms of R^{d} are the same as those described above.
s1 is 0 or 1.

In particular, X³² is preferably —O—, —S—, —N(R^{d})—, —C(O)—, —C(O)S—, —N(R^{d})C(O)N(R^{d})—, —OC(O)N(R^{d})—, or —C(O)N(R^{d})—, and more preferably —C(O)O— or —C(O)N(R^{d})—.

Q^{b1} is a single bond or an alkylene group. Note that the alkylene group may have —O— or a dialkylsilylene group. The alkylene group may have a plurality of groups selected from the group consisting of —O—, a divalent organopolysiloxane residue, and a dialkylsilylene group.

Note that when the alkylene group has —O—, a divalent organopolysiloxane residue, or a dialkylsilylene group, it preferably has these groups between carbon atoms.

The number of carbon atoms of the alkylene group represented by Q^{b1} is preferably 1 to 30, more preferably 1 to 20, still more preferably 2 to 20, and particularly preferably 2 to 6. Further, the aforementioned number of carbon atoms may be 1 to 10.

In particular, s1 is preferably 1, and Q^{b1} is preferably an alkylene group having a number of carbon atoms of 2 to 6.

Examples of [—(X³²)ₛ₁-Q^{b1}-Si(R)ₙL₃₋ₙ] in the group (3-1A-1) include groups shown below. In the formulas shown below, * indicates a position of a bond with L².

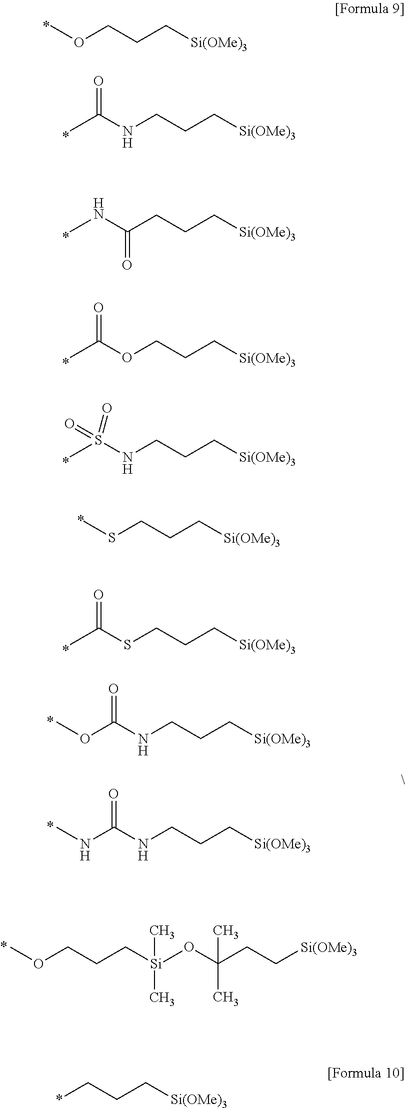

In the group (3-1A-2), X³³ is —O—, —S—, —N(R^{d})—, —C(O)—, —C(O)O—, —C(O)S—, —SO₂N(R^{d})—, —N(R^{d})C(O)N(R^{d})—, —OC(O)N(R^{d})—, or —C(O)N(R^{d})—.

Definitions and preferred forms of R^{d} are the same as those described above.
s2 is 0 or 1. s2 is preferably 0 in view of the ease of the manufacturing of the compound.

Q^{a2} is a single bond, an alkylene group, —C(O)—, or a group having, between carbon atoms of an alkylene group having a number of carbon atoms of 2 or greater, an etheric oxygen atom, —C(O)—, —C(O)O—, —N(R^{d})C(O)N(R^{d})—, —N(R^{d})C(O)O—, —SO₂N(R^{d})—, —C(O)N(R^{d})—, or —NH—.

Definitions and preferred forms of R^{d} are the same as those described above.

The number of carbon atoms of the alkylene group represented by Q^{a2} is preferably 1 to 20, more preferably 1 to 10, still more preferably 1 to 6, and particularly preferably 1 to 3.

The number of carbon atoms of the group having, between carbon atoms of an alkylene group having a number of carbon atoms of 2 or greater represented by Q^{a2}, an etheric oxygen atom, —C(O)—, —C(O)O—, —N(R^{d})C(O)N(R^{d})—, —N(R^{d})C(O)O—, —SO₂N(R^{d})—, —C(O)N(R^{d})—, or —NH— is preferably 2 to 10 and more preferably 2 to 6.

Q^{a2} is preferably a single bond in view of the ease of the manufacturing of the compound.

Q^{b2} is an alkylene group or a group having a divalent organopolysiloxane residue, an etheric oxygen atom, or —NH— between carbon atoms of an alkylene group having a number of carbon atoms of 2 or greater.

The number of carbon atoms of the alkylene group represented by Q^{b2} is preferably 1 to 30, more preferably 1 to 20, still more preferably 2 to 20, and may be 2 to 10 or 2 to 6. For example, the number of carbon atoms is 2, 3, 8, 9 or 11. Further, the number of carbon atoms may be 1 to 10.

The number of carbon atoms of the group having a divalent organopolysiloxane residue, an etheric oxygen atom, or —NH— between carbon atoms of an alkylene group having a number of carbon atoms of 2 or greater, represented by Q^{b2} is preferably 2 to 10 and more preferably 2 to 6.

Q^{b2} is preferably —CH₂CH₂CH₂— or —CH₂CH₂OCH₂CH₂CH₂— (note that the right side is bonded to Si) in view of the ease of the manufacturing of the compound.

The two [-Q^{b2}-Si(R)ₙL₃₋ₙ] may be the same as each other or different from each other.

Examples of [—(X³³)ₛ₂-Q^{a2}-N[-Q^{b2}-Si(R)ₙL₃₋ₙ]₂] in the group (3-1A-2) include groups shown below. In the below-shown formulas, * indicates a position of a bond with L².

Further, in the formula, α in (CH₂)_{α} that is bonded to a reactive silyl group is an integer indicating the number of methylene groups, is preferably 1 to 30, more preferably 1 to 20, still more preferably 2 to 20, and may be 2 to 10 or 2 to 6. For example, the number of carbon atoms is 2, 3, 8, 9 or 11. Further, the aforementioned number of carbon atoms may be 1 to 10. A plurality of a contained in the same compound may be the same as each other or different from each other, and is preferably the same as each other. For example, a plurality of a contained in the same compound are all 2, 3, 8, 9 or 11. The same applies hereinafter.

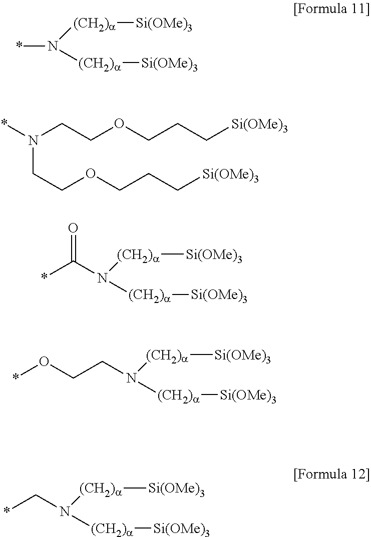

In the group (3-1A-3), Q^{a3} is a single bond, or an alkylene group which may have an etheric oxygen atom. In view of the ease of the manufacturing of the compound, Q^{a3} is preferably a single bond.

The number of carbon atoms of the alkylene group which may have an etheric oxygen atom is preferably 1 to 10 and more preferably 2 to 6.

R^{g} is a hydrogen atom, a hydroxyl group, or an alkyl group.

In view of the ease of the manufacturing of the compound, R^{g} is preferably a hydrogen atom or an alkyl group. The number of carbon atoms of the alkyl group is preferably 1 to 10, more preferably 1 to 4, and still more preferably 1 (i.e. a methyl group).

Q^{b3} is an alkylene group, or a group having an etheric oxygen atom or a divalent organopolysiloxane residue between carbon atoms of an alkylene group having a number of carbon atoms of 2 or greater.

The number of carbon atoms of the alkylene group represented by Q^{b3} is preferably 1 to 30, more preferably 1 to 20, still more preferably 2 to 20, and may be 2 to 10 or 2 to 6. For example, the number of carbon atoms is 2, 3, 8, 9 or 11. Further, the aforementioned number of carbon atoms may be 1 to 10.

The number of carbon atoms of the group having an etheric oxygen atom or a divalent organopolysiloxane residue between carbon atoms of an alkylene group having a number of carbon atoms of 2 or greater, represented by Q^{b3} is preferably 2 to 20, more preferably 2 to 10, and still more preferably 2 to 6.

Q^{b3} is preferably —CH₂CH₂—, —CH₂CH₂CH₂—, or —CH₂CH₂CH₂CH₂CH₂CH₂CH₂CH₂— in view of the ease of the manufacturing of the compound.

The two [-Q^{b3}-Si(R)ₙL₃₋ₙ] may be the same as each other or different from each other.

Examples of the group (3-1A-3) include groups shown below. In the below-shown formulas, * indicates a position of a bond with L².

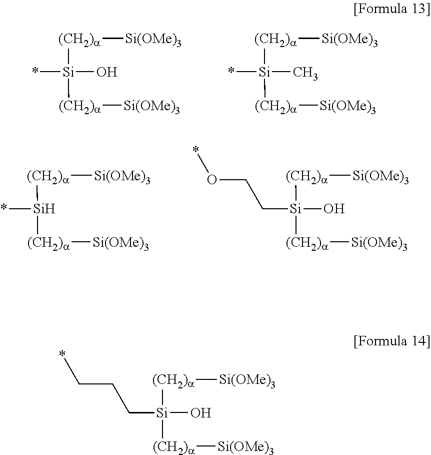

In the group (3-1A-4), Q^{c} is —C(O)O—, —SO₂N(R^{d})—, or —C(O)N(R^{d})—.

The definition of R³¹ is the same as that described above. When w1 is 1 or 2, R³¹ is preferably a hydrogen atom.
s4 is 0 or 1.
Q^{a4} is a single bond or an alkylene group which may have an etheric oxygen atom.

The number of carbon atoms of the alkylene group which may have an etheric oxygen atom is preferably 1 to 20, more preferably 1 to 10, still more preferably 1 to 6, and particularly preferably 1 to 3.
t4 is 0 or 1. Note that when Q^{a4} is a single bond, it is 0.

In view of the ease of the manufacturing of the compound, when s4 is 0, -Q^{a4}-(O)ₜ₄— is preferably a single bond, —CH₂O—, —CH₂OCH₂—, —CH₂OCH₂CH₂O—, —CH₂OCH₂CH₂OCH₂—, or —CH₂OCH₂CH₂CH₂CH₂OCH₂-(note that the left side is bonded to L²). Further, when s4 is 1, it is preferably a single bond, —CH₂—, or —CH₂CH₂—.

Q^{b4} is an alkylene group, and the aforementioned alkylene group may have —O—, —C(O)N(R^{d})— (the definition of R^{d} is the same as that described above), a divalent organopolysiloxane residue, or a dialkylsilylene group.

Note that when the alkylene group has —O—, it preferably has —O— between carbon atoms. Further, when the alkylene group has —C(O)N(R^{d})—, a dialkylsilylene group, or a divalent organopolysiloxane residue, it preferably has these groups between carbon atoms or at the end of the side which is bonded to (O)ᵤ₄.

The number of carbon atoms of the alkylene group represented by Q^{b4} is preferably 1 to 30, more preferably 1 to 20, still more preferably 2 to 20, and may be 2 to 11 or 2 to 6. For example, the number of carbon atoms is 2, 3, 8, 9 or 11. Further, the aforementioned number of carbon atoms may be 1 to 11.
u4 is 0 or 1.

In view of the ease of the manufacturing of the compound, —(O)ᵤ₄-Q^{b4}- is preferably —CH₂CH₂—, —CH₂CH₂CH₂—, —(CH₂)_{b}—, —CH₂OCH₂CH₂CH₂—, —CH₂OCH₂CH₂CH₂CH₂CH₂—, —OCH₂CH₂CH₂—, —OSi(CH₃)₂CH₂CH₂CH₂—, —OSi(CH₃)₂OSi(CH₃)₂CH₂CH₂CH₂—, or —CH₂CH₂CH₂Si(CH₃)₂PhSi(CH₃)₂CH₂CH₂— (note that the right side is bonded to Si). b is an integer of 4 to 11.
w1 is an integer of 0 to 2, preferably 0 or 1, and more preferably 0.

When there are two or more [—(O)ᵤ₄-Q^{b4}-Si(R)ₙL₃₋ₙ], the two or more [—(O)ᵤ₄-Q^{b4}-Si(R)ₙL₃₋ₙ] may be the same as each other or different from each other.

When there are two or more R³¹, the two or more (—R³¹) may be the same as each other or different from each other.

Examples of [-[Q^{e}]ₛ₄-Q^{a4}-(O)ₜ₄—C[—(O)ᵤ₄-Q^{b4}-Si(R)ₙL₃₋ₙ]_{3-w1}(—R³¹)_{w1}] in the group (3-1A-4) include groups shown below. In the formulas shown below, * indicates a position of a bond with L².

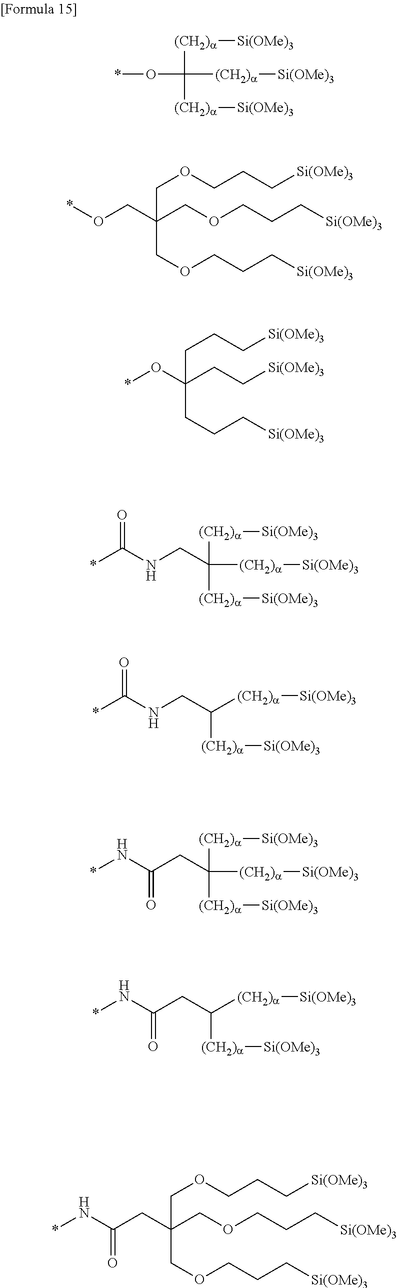

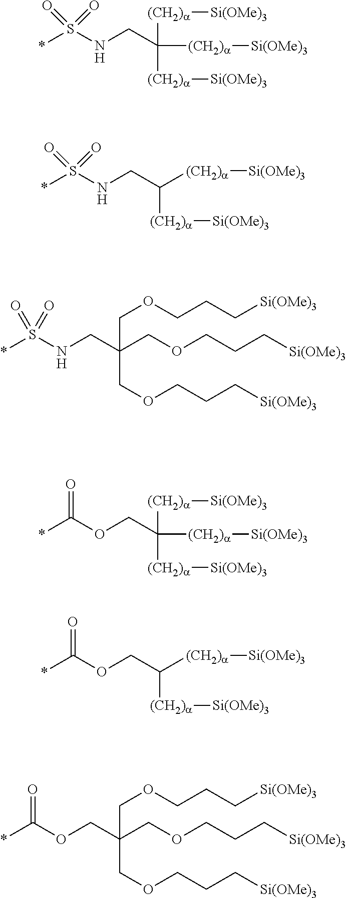

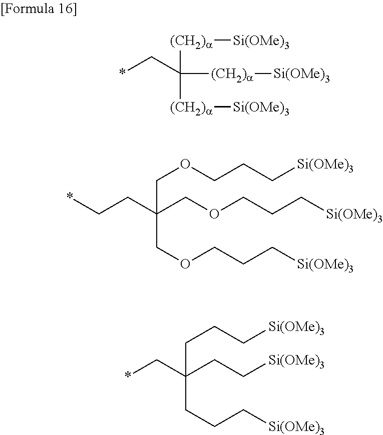

In the group (3-1A-5), Q^{a5} is an alkylene group which may have an etheric oxygen atom. The number of carbon atoms of the alkylene group which may have an etheric oxygen atom is preferably 1 to 10 and more preferably 2 to 6. Q^{a5} is preferably —OCH₂CH₂CH₂—, —OCH₂CH₂OCH₂CH₂CH₂—, —CH₂CH₂—, or —CH₂CH₂CH₂— (note that the right side is bonded to Si) in view of the ease of the manufacturing of the compound.

Q^{b5} is an alkylene group, or a group which has an etheric oxygen atom or a divalent organopolysiloxane residue between carbon atoms of an alkylene group having a number of carbon atoms of 2 or greater.

The number of carbon atoms of the alkylene group represented by Q^{b5} is preferably 1 to 30, more preferably 1 to 20, still more preferably 2 to 20, and may be 2 to 10 or 2 to 6. For example, the number of carbon atoms is 2, 3, 8, 9 or 11. Further, the aforementioned number of carbon atoms may be 1 to 10.

The number of carbon atoms of the group having an etheric oxygen atom or a divalent organopolysiloxane residue between carbon atoms of an alkylene group having a number of carbon atoms of 2 or greater, represented by Q^{b5} is preferably 2 to 20, more preferably 2 to 10, and still more preferably 2 to 6.

Q^{b5} is preferably —CH₂CH₂CH₂— or —CH₂CH₂OCH₂CH₂CH₂— (note that the right side is bonded to Si(R)ₙL₃₋ₙ) in view of the ease of the manufacturing of the compound.

The three [-Q^{b5}-Si(R)ₙL₃₋ₙ] may be the same as each other or different from each other.

Examples of the group (3-1A-5) include groups shown below. In the formulas shown below, * indicates a position of a bond with L².

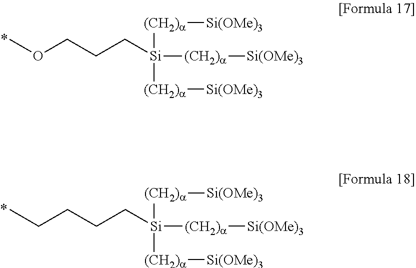

The definition of Q^{e} in the group (3-1A-6) is the same as that defined in the above-described group (3-1A-4).
v is 0 or 1.
Q^{a6} is an alkylene group which may have an etheric oxygen atom.

The number of carbon atoms of the alkylene group which may have an etheric oxygen atom is preferably 1 to 10 and more preferably 2 to 6.
Q^{a6} is preferably —CH₂OCH₂CH₂CH₂—, —CH₂OCH₂CH₂OCH₂CH₂CH₂—, —CH₂CH₂—, or —CH₂CH₂CH₂— in view of the ease of the manufacturing of the compound (note that the right side is bonded to Z^{a}).
Z^{a} is an organopolysiloxane residue having a valence of (w2+1), or a group having a valence of (w2+1) and having an alkylene group between organopolysiloxane residues.
w2 is an integer of 2 to 7.

Examples of the organopolysiloxane residue having a valence of (w2+1), and the group having a valence of (w2+1) and having an alkylene group between organopolysiloxane residues include groups shown below. Note that R^{a} in the below-shown formulas is the same as that described above. * indicates a bonding position.

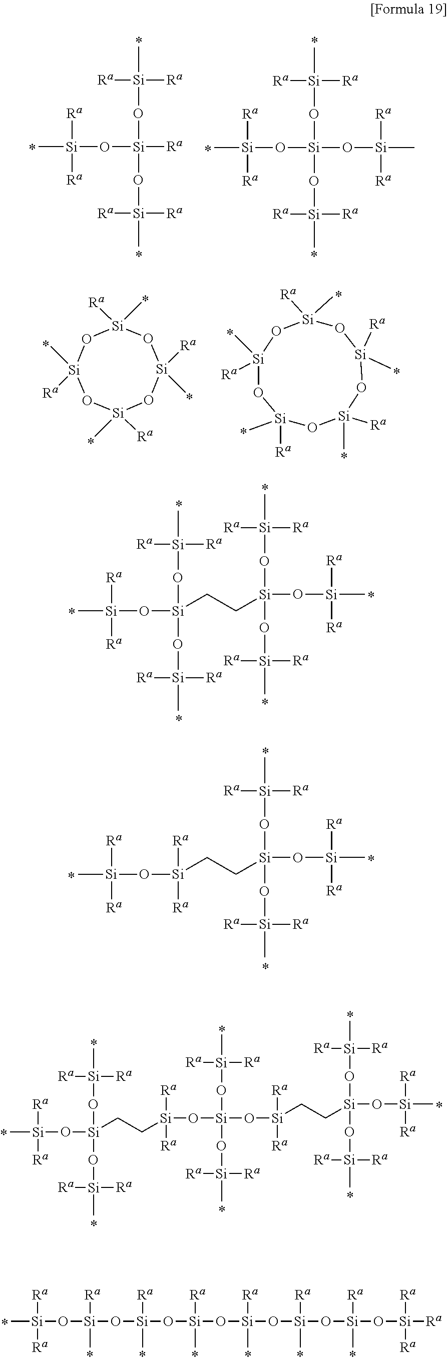

Q^{b6} is an alkylene group, or a group having an etheric oxygen atom or a divalent organopolysiloxane residue between carbon atoms of an alkylene group having a number of carbon atoms of 2 or greater.

The number of carbon atoms of the alkylene group represented by Q^{b6} is preferably 1 to 30, more preferably 1 to 20, still more preferably 2 to 20, and may be 2 to 10 or 2 to 6. For example, the number of carbon atoms is 2, 3, 8, 9 or 11. Further, the aforementioned number of carbon atoms may be 1 to 10.

The number of carbon atoms of the group having an etheric oxygen atom or a divalent organopolysiloxane residue between carbon atoms of an alkylene group having a number of carbon atoms of 2 or greater, represented by Q^{b6} is preferably 2 to 20, more preferably 2 to 10, and still more preferably 2 to 6.
Q^{b6} is preferably —CH₂CH₂— or —CH₂CH₂CH₂— in view of the ease of the manufacturing of the compound.
w2 [-Q^{b6}-Si(R)ₙL₃₋ₙ](i.e., w2 pieces of [-Q^{b6}-Si(R)ₙL₃₋ₙ]) may be the same as each other or different from each other.

Examples of [-[Q^{e}]ᵥ-Q^{a6}-Z^{a}[-Q^{b6}-Si(R)˜L₃₋ₙ]_{w2}] in the group (3-1A-6) include groups shown below. In the below-shown formulas, * indicates a position of a bond with L².

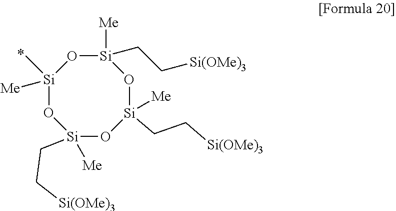

In the group (3-1A-7), Z° is a hydrocarbon group having a valence of (w3+w4+1).
w3 is an integer of 4 or greater.
w4 is an integer of 0 or greater.

The definitions and the preferred ranges of Q^{e}, s4, Q^{a4}, t4, Q^{b4}, and u4 are the same as those of the same symbols in the group (3-1A-4).

Z^{c} may consist of a hydrocarbon chain, may have an etheric oxygen atom between carbon atoms of a hydrocarbon chain, and preferably consists of a hydrocarbon chain.

The valence of Z^{c} is preferably 5 to 20, more preferably 5 to 10, still more preferably 5 to 8, and particularly preferably 5 to 6.

The number of carbon atoms of Z^{c} is preferably 3 to 50, more preferably 4 to 40, and still more preferably 5 to 30.
w3 is preferably 4 to 20, more preferably 4 to 16, still more preferably 4 to 8, and particularly preferably 4 to 5.
w4 is preferably 0 to 10, more preferably 0 to 8, still more preferably 0 to 6, particularly preferably 0 to 3, and most preferably 0 to 1.

When there are two or more [—(O-Q^{b4})ᵤ₄-Si(R)ₙL₃₋ₙ], the two or more [—(O-Q^{b4})ᵤ₄-Si(R)ₙL₃₋ₙ] may be the same as each other or different from each other.

Examples of [-[Q^{e}]ₛ₄-Q^{a4}-(O)ₜ₄—Z^{c}[—(O-Q^{b4})ᵤ₄-Si(R)ₙL₃₋ₙ]_{w3}(—OH)_{w4}] in the group (3-1A-7) include groups shown below. In the formulas shown below, * indicates a position of a bond with L².

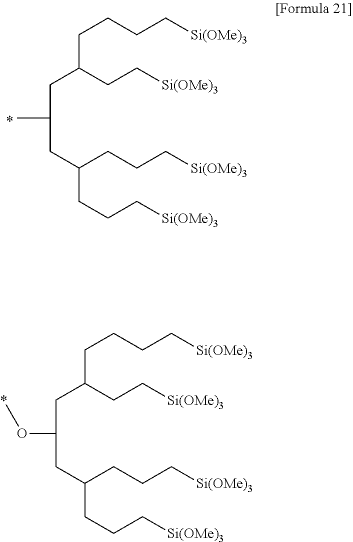

L³ in Formula (2) may be a group (g2-1) (note that d1+d3=1 and q=d2+d4), a group (g2-2) (note that q=e2), a group (g2-3) (note that q=2), a group (g2-5) (note that q=i2), a group (g2-6) (note that q=1), or a group (g2-7) (note that q=i3+1).

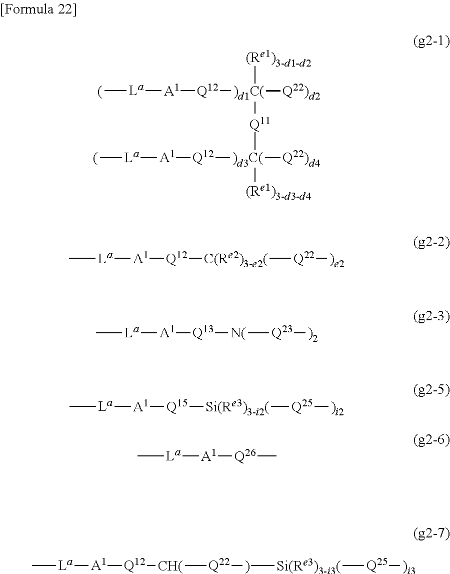

Note that in Formulas (g2-1) to (g2-3) and (g2-5) to (g2-7), the L^{a} side is bonded to L², and the Q²², Q²³, Q²⁵ or Q²⁶ side is bonded to [—Si(R)ₙL₃₋ₙ].

Definitions and preferred forms of L^{a} are the same as those described above.
A¹ is a single bond, —C(O)NR⁶ —, —C(O)—, —OC(O)O—, —NHC(O)O—, —NHC(O)NR⁶—, —O—, or —SO₂NR⁶—.
Q¹¹ is a single bond, —O—, an alkylene group, or a group having —C(O)NR⁶—, —C(O)—, —NR⁶ —, or —O— between carbon atoms of an alkylene group having a number of carbon atoms of 2 or greater.
Q¹² is a single bond, an alkylene group, or a group having —C(O)NR⁶—, —C(O)—, —NR⁶ —, or —O— between carbon atoms of an alkylene group having a number of carbon atoms of 2 or greater.
Q¹³ is a single bond (note that A¹ is —C(O)—), an alkylene group, a group having —C(O)NR⁶ —, —C(O)—, —NR⁶ —, or —O— between carbon atoms of an alkylene group having a number of carbon atoms of 2 or greater, or a group having —C(O)— at the end on the N side of an alkylene group.
Q¹⁵ is an alkylene group, or a group having —C(O)NR⁶ —, —C(O)—, —NR⁶— or —O— between carbon atoms of an alkylene group having a number of carbon atoms of 2 or greater.
Q²² is an alkylene group, a group having —C(O)NR⁶—, —C(O)—, —NR⁶—, or —O— between carbon atoms of an alkylene group having a number of carbon atoms of 2 or greater, a group having —C(O)NR⁶—, —C(O)—, —NR⁶—, or —O— at the end on the side on which the alkylene group is not connected to Si, or a group having —C(O)NR⁶—, —C(O)—, —NR⁶—, or —O— between carbon atoms of an alkylene group having a number of carbon atoms of 2 or greater and having —C(O)NR⁶—, —C(O)—, —NR⁶—, or —O— at the end on the side on which the alkylene group is not connected to Si. Further, when there are two or more Q²², the two or more Q²² may be the same as each other or different from each other.
Q²³ is an alkylene group, or a group having —C(O)NR⁶—, —C(O)—, —NR⁶—, or —O— between carbon atoms of an alkylene group having a number of carbon atoms of 2 or greater. Further, the two Q²³ may be the same as each other or different from each other.
Q²⁵ is an alkylene group or a group having —C(O)NR⁶—, —C(O)—, —NR⁶—, or —O— between carbon atoms of an alkylene group having a number of carbon atoms of 2 or greater. Further, when there are two or more Q²⁵ the two or more Q²⁵ may be the same as each other or different from each other.
Q²⁶ is an alkylene group or a group having —C(O)NR⁶—, —C(O)—, —NR⁶—, or —O— between carbon atoms of an alkylene group having a number of carbon atoms of 2 or greater.

When Q²², Q²³, Q²⁵ and Q²⁶ are alkylene groups, the number of carbon atoms is preferably 1 to 20, more preferably 1 to 10, and still more preferably 1 to 6.
R^{e1} is a hydrogen atom or an alkyl group, and two or more R^{e1} may be the same as each other or different from each other.
R^{e2} is a hydrogen atom, a hydroxyl group, an alkyl group, or an acyloxy group.
R^{e3} is an alkyl group.
R⁶ is a hydrogen atom, an alkyl group having a number of carbon atoms of 1 to 6, or a phenyl group.
d1 is 0 or 1. d3 is 0 or 1. Further, d1+d3 is 1.
d2 is an integer of 0 to 3. d4 is an integer of 0 to 3. Further, d2+d4 is an integer of 1 to 5.
d1+d2 is an integer of 1 to 3.
d3+d4 is an integer of 1 to 3.
e2 is an integer of 1 to 3, and is preferably 2 or 3.
i2 is an integer of 1 to 3, and preferably 2 or 3.
i3 is 2 or 3.

The number of carbon atoms of the alkylene group of Q¹², Q¹³, Q¹⁵, Q²², Q²³, Q²⁵ and Q²⁶ is preferably 1 to 30, more preferably 1 to 20, still more preferably 2 to 20, and may be 2 to 10 or 2 to 6 in view of the ease of the manufacturing of the compound and because the light stability of the surface-treated layer becomes more excellent. For example, the number of carbon atoms is 2, 3, 8, 9 or 11. Further, the aforementioned number of carbon atoms may be 1 to 10, 1 to 6, or 1 to 4. However, when the alkylene group has a specific bond between carbon atoms, the lower limit value of its number of carbon atoms is 2.

The number of carbon atoms of the alkyl group of R^{e2} or R^{e3} is preferably 1 to 6, more preferably 1 to 3, and particularly preferably 1 to 2 in view of the ease of the manufacturing of the compound.

The number of carbon atoms of the alkyl group moiety of the acyloxy group of R^{e2} is preferably 1 to 6, more preferably 1 to 3, and still more preferably 1 to 2 in view of the ease of the manufacturing of the compound.

Examples of other forms of L³ in Formula (2) include a group (g2-8) (note that d1+d3=1, q=d2×k3+d4×k3), a group (g2-9) (note that q=e2×k3), a group (g2-10) (note that q=2×k3), a group (g2-12) (note that q=i2×k3), a group (g2-13) (note that q=k3), or a group (g2-14) (note that q=i3×k3+k3).

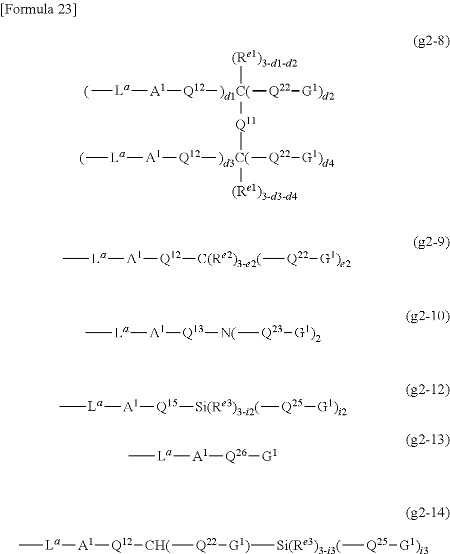

Note that in Formulas (g2-8) to (g2-10) and (g2-12) to (g2-14), the L^{a} side is bonded to L², and the G¹ side is bonded to [—Si(R)ₙL₃₋ₙ].

G¹ is the below-shown group (g3), and two or more G¹ included in A may be the same as each other or different from each other. Symbols other than G¹ are the same as those in Formulas (g2-1) to (g2-3) and (g2-5) to (g2-7).

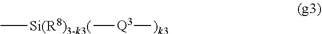

Note that in the group (g3), the Si side is connected to Q²², Q²³, Q²⁵ or Q²⁶, and the Q³ side is connected to [—Si(R)ₙL₃₋ₙ]. R⁸ is an alkyl group. Q³ is an alkylene group, a group having —C(O)NR⁶—, —C(O)—, —NR⁶—, or —O-between carbon atoms of an alkylene group having a number of carbon atoms of 2 or greater, or (OSi(R⁹)₂)ₚ—O—. Further, two or more Q³ may be the same as each other or different from each other. k3 is 2 or 3. R⁶ is a hydrogen atom, an alkyl group having a number of carbon atoms of 1 to 6, or a phenyl group. R⁹ is an alkyl group, a phenyl group, or an alkoxy group, and two R⁹ may be the same as each other or different from each other. p is an integer of 0 to 5. Further, when p is 2 or greater, two or more (OSi(R⁹)₂) may be the same as each other or different from each other.

The number of carbon atoms of the alkylene group of Q³ is preferably 1 to 30, more preferably 1 to 20, still more preferably 2 to 20, and may be 2 to 10 or 2 to 6 in view of the ease of the manufacturing of the compound and because the light stability of the surface-treated layer becomes more excellent. For example, the number of carbon atoms is 2, 3, 8, 9 or 11. Further, the aforementioned number of carbon atoms may be 1 to 10, 1 to 6, or 1 to 4. However, when the alkylene group has a specific bond between carbon atoms, the lower limit value of its number of carbon atoms is 2.

The number of carbon atoms of the alkyl group of R⁸ is preferably 1 to 6, more preferably 1 to 3, and still more preferably 1 to 2 in view of the ease of the manufacturing of the compound.

The number of carbon atoms of the alkyl group of R⁹ is preferably 1 to 6, more preferably 1 to 3, and still more preferably 1 to 2 in view of the ease of the manufacturing of the compound.

The number of carbon atoms of the alkoxy group of R⁹ is preferably 1 to 6, more preferably 1 to 3, and still more preferably 1 to 2 because the storage stability of the compound becomes more excellent.
p is preferably 0 or 1.

The compound (2) may be a compound in which: L¹ is an alkylene group; L² is a specific ring structure; and L³ is an alkylene group. The alkylene groups in L¹ and L³ may be linear or branched, and are preferably linear. The number of carbon atoms of the alkylene group in each of L¹ and L³ is preferably 1 to 30, and may be 1 to 25, 1 to 20, 1 to 10, or 5 to 10. For example, each of L¹ and L³ may be an alkylene group having a number of carbon atoms of 1 to 10 or 5 to 10, and L² may be a combination of a specific ring structure(s). Note that in the compounds in the above-described preferred ranges and preferred combinations, q may be 1.

The compound represented by Formula (1-1) may be a compound represented by Formula (3).

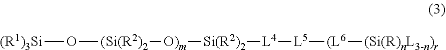

The definitions of R¹, R², m, R, L and n in Formula (3) are synonymous with R¹, R², m, R, L and n, respectively, in Formula (2), and their preferred forms are also the same as those described above.

In Formula (3), L⁴ is a single bond or a divalent linking group.

The divalent linking group represented by L⁴ is synonymous with the divalent linking group represented by L¹ in the above-shown Formula (2), and its preferred forms are also the same as those described above.

In particular, L⁴ is preferably a divalent alkylene group, —O—, —S—, —SO₂—, —N(R^{d})—, —C(O)—, —Si(R^{a})₂—, —OC(O)—, —C(O)O—, —C(O)S—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, an alkylene group having —C(O)—, an alkylene group having —C(O)N(R^{d})—, an alkylene group having —N(R^{d})C(O)—, an alkylene group having —OC(O)N(R^{d})—, an alkylene group having an etheric oxygen atom, an alkylene group having —S—, an alkylene group having —OC(O)—, an alkylene group having —C(O)O—, an alkylene group having —C(O)S—, an alkylene group having —N(R^{d})—, an alkylene group having —N(R^{d})C(O)N(R^{d})—, an alkylene group having —SO₂N(R^{d})—, or alkylene group-C(O)N(R^{d})-alkylene group, more preferably an alkylene group, —OC(O)—, an alkylene group having —C(O)—, an alkylene group having —C(O)N(R^{d})—, an alkylene group having —OC(O)N(R^{d})—, an alkylene group having an etheric oxygen atom, an alkylene group having —S—, an alkylene group having —C(O)O—, an alkylene group having —C(O)S—, an alkylene group having —N(R^{d})—, an alkylene group having —N(R^{d})C(O)N(R^{d})—, or alkylene group-C(O)N(R^{d})-alkylene group, and still more preferably an alkylene group having —C(O)— or alkylene group-C(O)N(R^{d})-alkylene group.

In Formula (3), L⁵ is an alicyclic group which may have a heteroatom having a valence of (r+1).

The alicyclic group which may have a heteroatom is a group consisting of the above-described specific ring structure, and its preferred forms are also the same as those described above.

In particular, L⁵ preferably contains a ring selected from the group consisting of a cyclopentane ring, a pyrrolidine ring, a cyclohexane ring, an adamantane ring, a piperidine ring, and condensed rings shown below, and more preferably contains an adamantane ring.

The definition of R is the same as that described above.

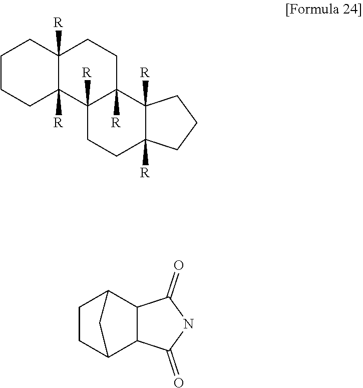

When one of the ring constituent atoms of the above-described alicyclic group has two bonds bonded to L⁴ or (L⁶-Si(R)ₙL₃₋ₙ), L⁴ and (-L⁶-Si(R)ₙL₃₋ₙ) may be bonded to the one of the ring constituent atoms, or two (-L⁶-Si(R)ₙL₃₋ₙ) may be bonded to the one of the atoms. L⁴ and (-L⁶-Si(R)ₙL₃₋ₙ) are preferably bonded to ring constituent atoms different from each other. When r is an integer of 2 or greater, r (-L⁶-Si(R)ₙL₃₋ₙ) (i.e., r pieces of (-L⁶-Si(R)ₙL₃₋ₙ)) may be bonded to ring constituent atoms different from each other, and two of them may be bonded to one ring constituent carbon atom. Further, there may be two or more ring constituent carbon atoms to each of which two (-L⁶-Si(R)ₙL₃₋ₙ) are bonded.

In the ring constituent atoms of the above-described alicyclic group, when there is a remaining bond(s) other than the bond(s) constituting the ring and the bond(s) bonded to L⁴ or L⁶, the remaining bond(s) is bonded to a hydrogen atom or a substituent. Examples of such substituents include a halogen atom, an alkyl group which may contain an etheric oxygen atom between carbon atoms, an alkenyl group, an allyl group, an alkoxy group, and an oxo group (═O). The remaining bond(s) is preferably bonded to a hydrogen atom or an alkyl group, and more preferably bonded to a hydrogen atom. The number of carbon atoms of the alkyl group is preferably 1 to 5, more preferably 1 to 3, and still more preferably 1.

In Formula (3), L⁶ is each independently a single bond or a divalent linking group.

The divalent linking group represented by L⁶ is synonymous with the divalent linking group represented by L¹ in the above-shown Formula (2), and its preferred forms are also the same as those described above.

When there are two or more L⁶, the two or more L⁶ may be the same as each other or different from each other.

In particular, L⁶ is preferably an alkylene group which may have an etheric oxygen atom. The number of carbon atoms of the alkylene group is preferably 1 to 30, more preferably 1 to 20, still more preferably 2 to 20, and may be 2 to 10, 2 to 6, or 2 to 5. For example, the number of carbon atoms is 2, 3, 8, 9 or 11. Further, the aforementioned number of carbon atoms may be 1 to 10.

In Formula (3), r is an integer of 1 or greater.
r is preferably an integer of 1 to 15, more preferably an integer of 1 to 6, still more preferably an integer of 2 to 4, and particularly preferably an integer of 2 or 3.

When r is an integer of 2 or greater, the plurality of [—Si(R)ₙL₃₋ₙ] may be the same as each other or different from each other. The plurality of [—Si(R)ₙL₃₋ₙ] are preferably the same as each other in view of the availability of raw materials and the ease of the manufacturing of the compound.

The group obtained by removing [Si(R)ₙL₃₋ₙ] from -L⁴-L⁵-(L⁶-Si(R)ₙL₃₋ₙ)ᵣ in Formula (3) may be a group (g2-4) shown below (note that r=h2).

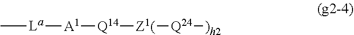

The definition of L^{a} is synonymous with L^{a} in Formula (3-1A-1), and its preferred forms are also the same as those described above.

A¹ is a single bond, —C(O)NR⁶—. —C(O)—, —OC(O)O—, —NHC(O)O—, —NHC(O)NR⁶—, —O—, or SO₂NR⁶—.

Q¹⁴ is a single bond, an alkylene group, or a group having —C(O)NR⁶—, —C(O)—, —NR⁶—, or —O— between carbon atoms of an alkylene group having a number of carbon atoms of 2 or greater when the atom in Z¹ to which Q¹⁴ is bonded is a carbon atom, and is a single bond (note that A¹ is —C(O)—), an alkylene group, a group having —C(O)NR⁶—, —C(O)—, —NR⁶—, or —O— between carbon atoms of an alkylene group having a number of carbon atoms of 2 or greater, or a group having —C(O)— at the end on the N side of an alkylene group when the atom in Z¹ to which Q¹⁴ is bonded is a carbon atom.

Q²⁴ is an alkylene group, a group having —C(O)NR⁶—, —C(O)—, —NR⁶—, or —O— between carbon atoms of an alkylene group having a number of carbon atoms of 2 or greater, a group having —C(O)NR⁶—, —C(O)—, —NR⁶—, or —O— at the end on the side on which the alkylene group is not connected to Si, or a group having —C(O)NR⁶—, —C(O)—, —NR⁶—, or —O— between carbon atoms of an alkylene group having a number of carbon atoms of 2 or greater and having —C(O)NR⁶—, —C(O)—, —NR⁶—, or —O— at the end on the side on which the alkylene group is not connected to Si when the atom in Z¹ to which Q²⁴ is bonded is a carbon atom. Q²⁴ is an alkylene group or a group having —C(O)NR⁶—, —C(O)—, —NR⁶—, or —O— between carbon atoms of an alkylene group having a number of carbon atoms of 2 or greater when the atom in Z¹ to which Q²⁴ is bonded is a nitrogen atom. When there are two or more Q²⁴, the two or more Q²⁴ may be the same as each other or different from each other.

R⁶ is a hydrogen atom, an alkyl group having a number of carbon atoms of 1 to 6, or a phenyl group.

The number of carbon atoms of the alkylene group of each of Q¹⁴ and Q²⁴ is preferably 1 to 30, more preferably 1 to 20, still more preferably 2 to 20, and may be 2 to 10 or 2 to 6 in view of the ease of the manufacturing of the compound and because the light stability of the surface-treated layer becomes more excellent. For example, the number of carbon atoms is 2, 3, 8, 9 or 11. Further, the aforementioned number of carbon atoms may be 1 to 10, 1 to 6, or 1 to 4. However, when the alkylene group has a specific bond between carbon atoms, the lower limit value of its number of carbon atoms is 2.

Z¹ is an alicyclic group a having a valence of (1+h2) and having a carbon atom or a nitrogen atom to which Q¹⁴ is directly bonded and a carbon atom or a nitrogen atom to which Q²⁴ is directly bonded.

Examples of the aforementioned alicyclic group represented by Z¹ include the above-described specific ring structure, and its preferred forms are also similar to those described above. Note that Q¹⁴ and Q²⁴ are directly bonded to the alicyclic group represented by Z¹, so that a situation in which, for example, the alkylene group is bonded to the ring structure, and Q¹⁴ and Q²⁴ are bonded to the alkylene group never occurs.

h2 is an integer of 1 or greater, and is preferably 2 to 6, more preferably 2 to 4, and still more preferably 2 or 3 in view of the ease of the manufacturing of the compound and because the light stability of the surface-treated layer becomes more excellent.

Examples of the group obtained by removing [Si(R)ₙL₃₋ₙ] from -L⁴-L⁵-(L⁶-Si(R)ₙL₃₋ₙ)ᵣ in Formula (3) include a group (g2-11) (note that r=h2×k3).

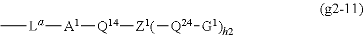

Note that in Formula (g2-11), the L⁴ side is bonded to [Si(R²)₂—], and the G¹ side is bonded to [—Si(R)ₙL₃₋ₙ].

The definition of G¹ is synonymous with G¹ in the above-described group (g2-9), and its preferred forms are also the same as those described above.

Definitions and preferred forms of L^{a}, A¹, Q¹⁴, Z¹ and Q²⁴ are the same as those described above.

The compound represented by Formula (1-1) may be a compound represented by Formula (4).

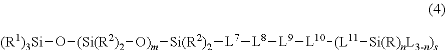

The definitions of R¹, R², m, R, L and n in Formula (4) are synonymous with R¹, R², m, R, L and n, respectively, in Formula (2), and their preferred forms are also the same as those described above.

In Formula (4), L⁷ and L⁹ are independently a single bond or a divalent linking group.

The divalent linking groups represented by L⁷ and L⁹ are synonymous with the divalent linking group represented by L¹ in the above-shown Formula (2), and their preferred forms are also the same as those described above.

In particular, L⁷ is preferably a single bond, an alkylene group, —O—, —S—, —SO₂—, —N(R^{d})—, —C(O)—, —Si(R^{a})₂—, —OC(O)—, —C(O)O—, —C(O)S—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, an alkylene group having —C(O)N(R^{d})—, an alkylene group having —N(R^{d})C(O)—, an alkylene group having —OC(O)N(R^{d})—, an alkylene group having an etheric oxygen atom, an alkylene group having —S—, an alkylene group having —OC(O)—, an alkylene group having —C(O)O—, an alkylene group having —C(O)S—, an alkylene group having —N(R^{d})—, an alkylene group having —N(R^{d})C(O)N(R^{d})—, an alkylene group having —SO₂N(R^{d})—, or alkylene group-C(O)N(R^{d})-alkylene group, more preferably a single bond, an alkylene group, —OC(O)—, an alkylene group having —C(O)N(R^{d})—, an alkylene group having —OC(O)N(R^{d})—, an alkylene group having an etheric oxygen atom, an alkylene group having —S—, an alkylene group having —C(O)O—, an alkylene group having —C(O)S—, an alkylene group having —N(R^{d})—, an alkylene group having —N(R^{d})C(O)N(R^{d})—, or alkylene group-C(O)N(R^{d})-alkylene group, and still more preferably a single bond, an alkylene group, or an alkylene group having an etheric oxygen atom.

Further, L⁹ is preferably a single bond, an alkylene group, —O—, —S—, —SO₂—, —N(R^{d})—, —C(O)—, —Si(R^{a})₂—, —OC(O)—, —C(O)O—, —C(O)S—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, an alkylene group having —C(O)N(R^{d})—, an alkylene group having —N(R^{d})C(O)—, an alkylene group having —OC(O)N(R^{d})—, an alkylene group having an etheric oxygen atom, an alkylene group having —S—, an alkylene group having —C(O)—, an alkylene group having —OC(O)—, an alkylene group having —C(O)O—, an alkylene group having —C(O)S—, an alkylene group having —N(R^{d})—, an alkylene group having —N(R^{d})C(O)N(R^{d})—, an alkylene group having —SO₂N(R^{d})—, or alkylene group-C(O)N(R^{d})-alkylene group, more preferably a single bond, an alkylene group, —C(O)—, —OC(O)—, an alkylene group having —C(O)N(R^{d})—, an alkylene group having —OC(O)N(R^{d})—, an alkylene group having an etheric oxygen atom, an alkylene group having —S—, an alkylene group having —C(O)—, an alkylene group having —C(O)O—, an alkylene group having —C(O)S—, an alkylene group having —N(R^{d})—, an alkylene group having —N(R^{d})C(O)N(R^{d})—, or alkylene group-C(O)N(R^{d})-alkylene group, and still more preferably a single bond, —C(O)—, or an alkylene group having —C(O)—.

In Formula (4), L⁸ is a divalent alicyclic group which may have a heteroatom.

The divalent alicyclic group which may have a heteroatom is a group having the above-described specific ring structure, and its preferred forms are also the same as those described above.

In particular, L⁸ preferably contains a ring selected from the group consisting of a cyclopentane ring, a cyclohexane ring, an adamantane ring, a piperidine ring, and condensed rings shown below, and more preferably contains an adamantane ring.

The definition of R is the same as that described above.

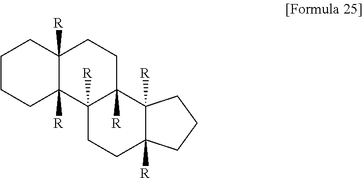

The bond(s) that does not constitute the ring of atoms constituting the specific ring structure of L⁸ is a bond(s) bonded to L⁷ or L⁹. When there is a remaining bond(s), the remaining bond(s) is bonded to a hydrogen atom or a substituent. Examples of such substituents include a halogen atom, an alkyl group (which may contain an etheric oxygen atom between carbon atoms), an alkenyl group, an allyl group, an alkoxy group, and an oxo group (═O). The remaining bond(s) is preferably bonded to a hydrogen atom or an alkyl group, and more preferably bonded to a hydrogen atom. The number of carbon atoms of the alkyl group is preferably 1 to 5, more preferably 1 to 3, and still more preferably 1.

In Formula (4), L¹⁰ is an alicyclic group which may have a heteroatom having a valence of (s+1).

The alicyclic group which may have a heteroatom is a group consisting of the above-described specific ring structure, and its preferred forms are also the same as those described above.

In particular, L¹⁰ preferably contains a ring selected from the group consisting of a cyclopentane ring, a pyrrolidine ring, a cyclohexane ring, an adamantane ring, a piperidine ring, and condensed rings shown below, and more preferably contains an adamantane ring.

When one of the ring constituent atoms of the above-described alicyclic group has two bonds bonded to L⁹ or (L¹¹-Si(R)ₙL₃₋ₙ), L⁹ and (-L¹¹-Si(R)ₙL₃₋ₙ) may be bonded to the one of the ring constituent atoms, or two (-L¹¹-Si(R)ₙL₃₋ₙ) may be bonded to the one of the atoms. L⁹ and (-L¹¹-Si(R)ₙL₃₋ₙ) are preferably bonded to ring constituent atoms different from each other. When s is an integer of 2 or greater, s (-L¹¹-Si(R)ₙL₃₋ₙ) (i.e., s pieces of (-L¹¹-Si(R)ₙL₃₋ₙ)) may be bonded to ring constituent atoms different from each other, and two of them may be bonded to one ring constituent carbon atom. Further, there may be two or more ring constituent carbon atoms to each of which two (-L¹¹-Si(R)ₙL₃₋ₙ) are bonded.

In the ring constituent atoms of the above-described alicyclic group, when there is a remaining bond(s) other than the bond(s) constituting the ring and the bond(s) bonded to L⁹ or L¹¹, the remaining bond(s) is bonded to a hydrogen atom or a substituent. Examples of such substituents include a halogen atom, an alkyl group (which may contain an etheric oxygen atom between carbon atoms), an alkenyl group, an allyl group, an alkoxy group, and an oxo group (═O). The remaining bond(s) is preferably bonded to a hydrogen atom or an alkyl group, and more preferably bonded to a hydrogen atom. The number of carbon atoms of the alkyl group is preferably 1 to 5, more preferably 1 to 3, and still more preferably 1.

In Formula (4), L¹¹ is each independently a single bond or a divalent linking group.

The divalent linking group represented by L¹¹ is synonymous with the divalent linking group represented by L¹ in the above-shown Formula (2), and its preferred forms are also the same as those described above.

When there are two or more L¹¹, the two or more L¹¹ may be the same as each other or different from each other.

In particular, L¹¹ is preferably a single bond, or an alkylene group which may have an etheric oxygen atom. The number of carbon atoms of the alkylene group is preferably 1 to 30, more preferably 1 to 20, still more preferably 2 to 20, and may be 2 to 10, 2 to 6, or 2 to 5. For example, the number of carbon atoms is 2, 3, 8, 9 or 11. Further, the aforementioned number of carbon atoms may be 1 to 10.

In Formula (4), s is an integer of 1 or greater.
s is preferably an integer of 1 to 15, more preferably an integer of 1 to 6, still more preferably an integer of 1 to 4, and particularly preferably an integer of 1 to 3.

When s is an integer of 2 or greater, the plurality of [—Si(R)ₙL₃₋ₙ] may be the same as each other or different from each other. The plurality of [—Si(R)ₙL₃₋ₙ] are preferably the same as each other in view of the availability of raw materials and the ease of the manufacturing of the compound.

The group obtained by removing [Si(R)ₙL₃₋ₙ] from -L⁹-L¹⁰-(L¹¹-Si(R)ₙL₃₋ₙ)ᵣ in Formula (4) may be the above-described group (g2-4) (note that s=h2).

Another form of the group obtained by removing [Si(R)ₙL₃₋ₙ] from -L⁹-L¹⁰(L¹¹-Si(R)ₙL₃₋ₙ)ᵣ in Formula (4) may be the above-described group (g2-11) (note that s=h2×k3).

Examples of the compound represented by Formula (1-1) include compounds represented by the below-shown formulas. The compounds represented by the below-shown formulas are preferred because they are industrially manufactured with ease, are easy to handle, and because the light stability of the surface-treated layer becomes more excellent. R^{t} in the compounds represented by the below-shown formulas is similar to [T-O—(Si(R²)₂—O)ₘ—Si(R²)₂] in the above-shown Formula (1-1), and its preferred forms are also similar to those described above. Further, n in the compounds represented by the below-shown formulas is 1 to 30, and is preferably 1 to 20 and more preferably 1 to 12.

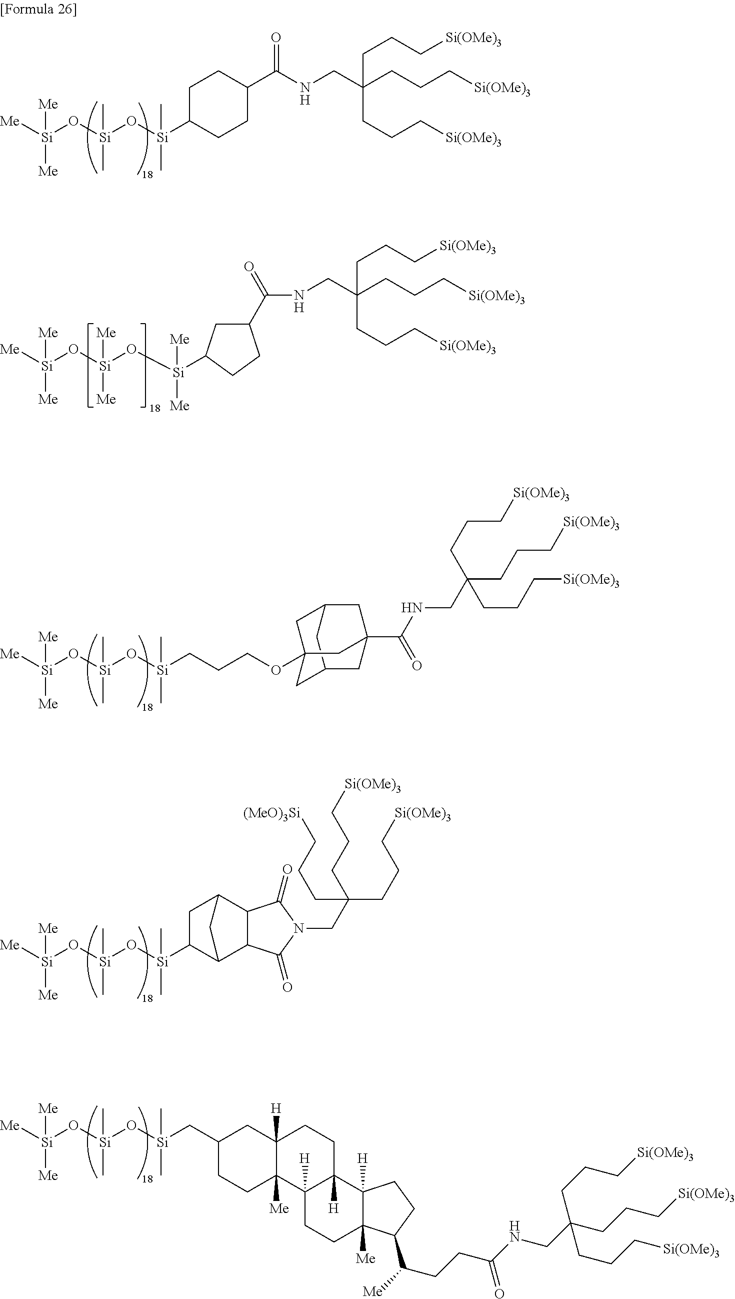

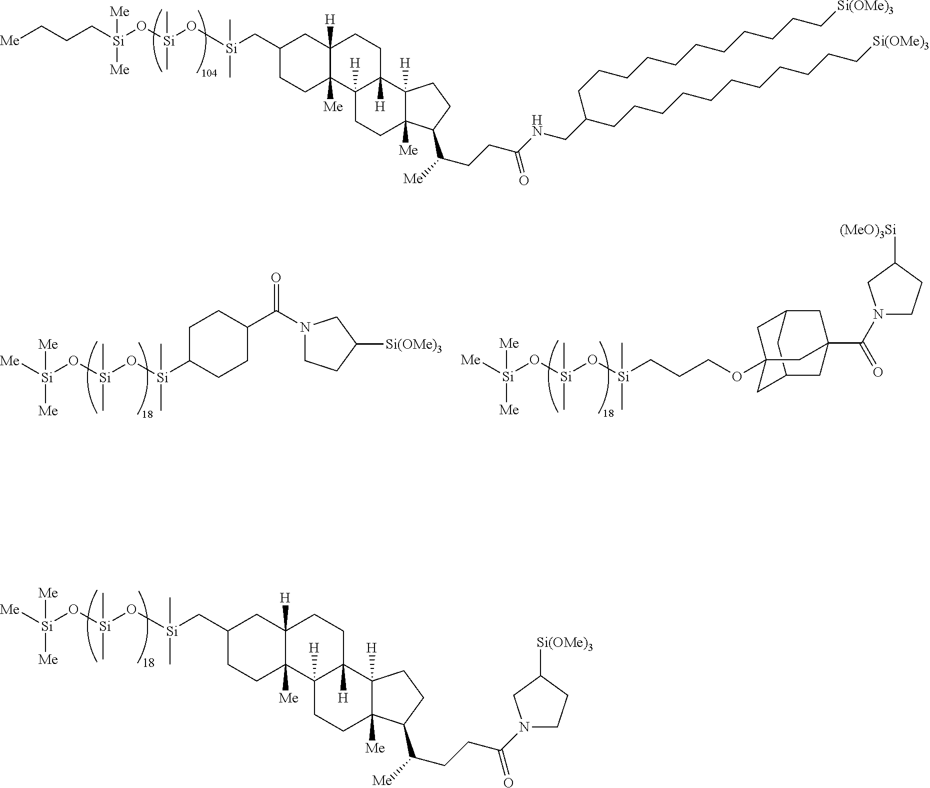

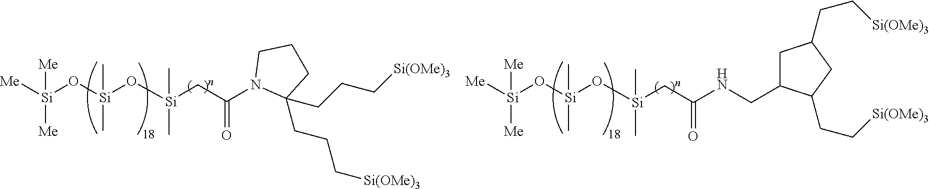

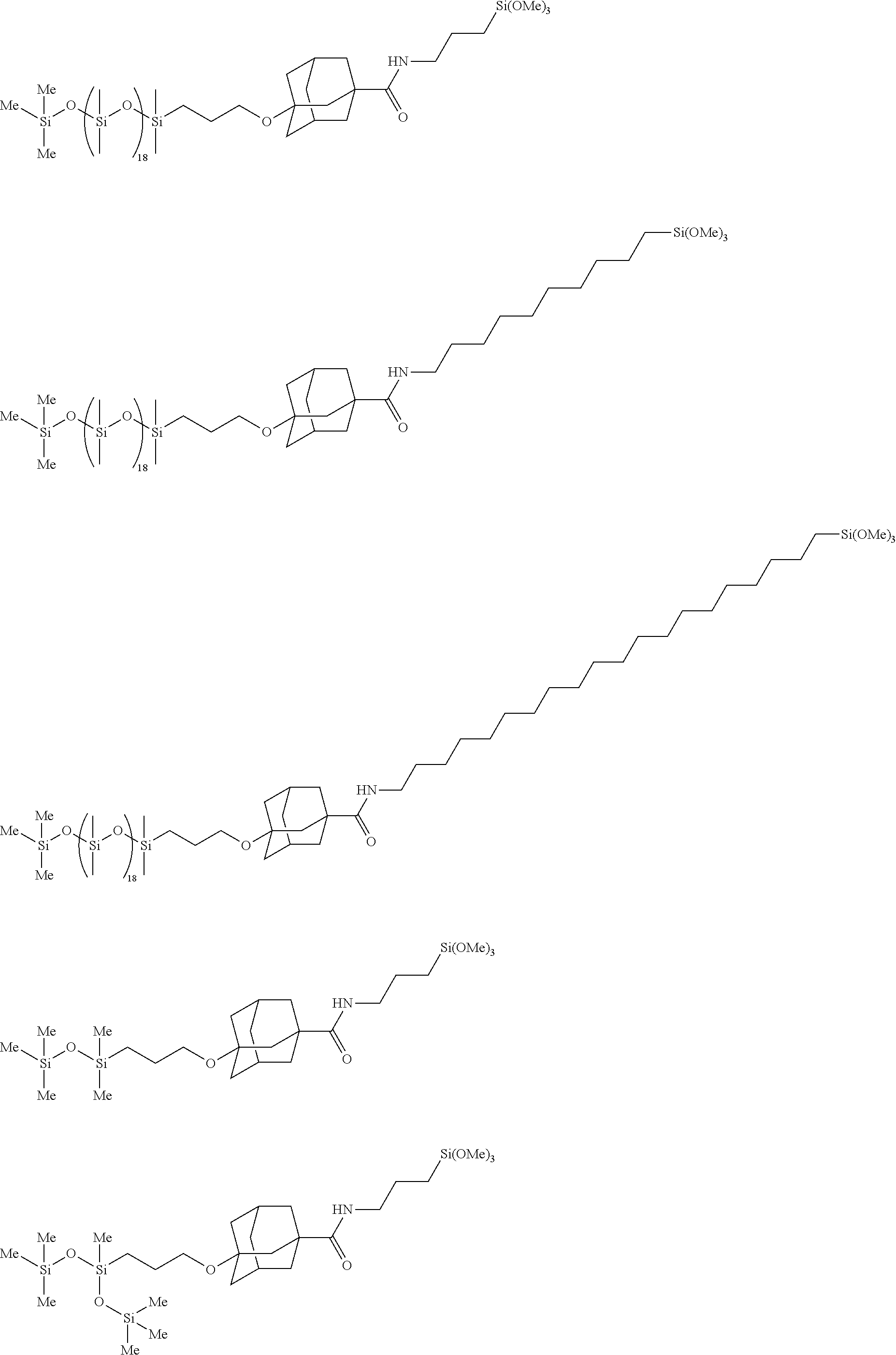

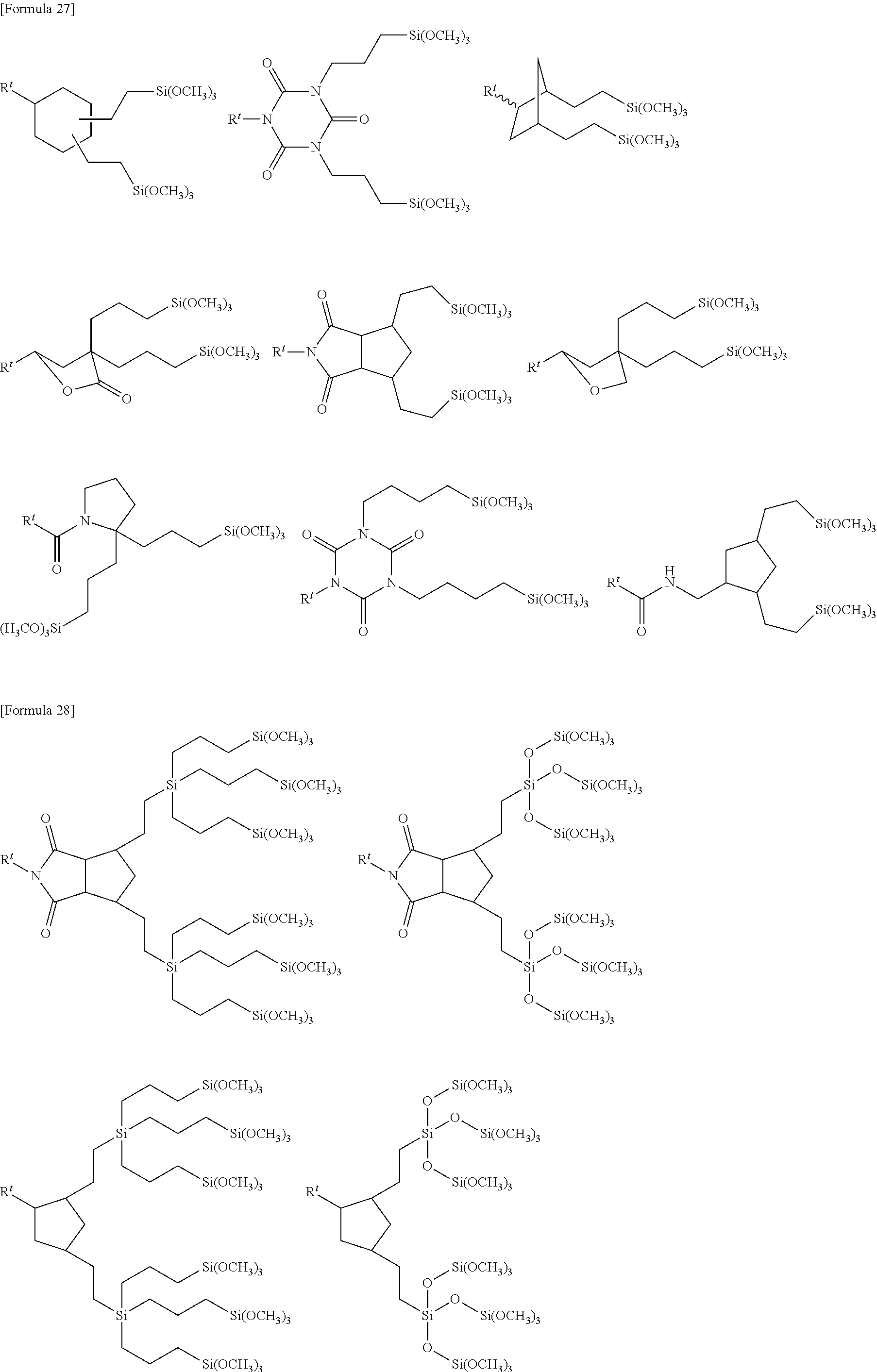

Further, the compound (1-1) may be a compound in which: L¹ is an alkylene group; L² is a specific ring structure; and L³ is an alkylene group. The alkylene groups of L¹ and L³ may be linear or branched, and are preferably linear. The number of carbon atoms of the alkylene group in each of L¹ and L³ is preferably 1 to 30, and may be 1 to 25, 1 to 20, 1 to 10, or 5 to 10. For example, each of L¹ and L³ may be an alkylene group having a number of carbon atoms of 1 to 10 or 5 to 10, and L² may be a combination of a specific ring structure(s). Note that in the compounds in the above-described preferred ranges and preferred combinations, q may be 1.

### <Compound Represented by Formula (1-2)>

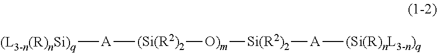

In Formula (1-2),
R² is each independently a hydrocarbon group or a trialkylsilyloxy group,
A is each independently a linking group having a valence of (q+1) and having an alicyclic structure which may have a heteroatom,
R is each independently a hydrocarbon group,
L is each independently a hydrolyzable group, a group having a hydrolyzable group, or a hydroxyl group,
m is a number of 0 or greater,
n is each independently an integer of 0 to 2, and
q is each independently an integer of 1 or greater.

The groups in Formula (1-2) are synonymous with the respective groups in Formula (1-1), and its preferred forms are also the same as those described above.

Further, the compound (1-2) may be a compound in which: L¹ is an alkylene group; L² is a specific ring structure; and L³ is an alkylene group. The alkylene groups of L¹ and L³ may be linear or branched, and are preferably linear. The number of carbon atoms of the alkylene group in each of L¹ and L³ is preferably 1 to 30, and may be 1 to 25, 1 to 20, 1 to 10, or 5 to 10. For example, each of L¹ and L³ may be an alkylene group having a number of carbon atoms of 1 to 10 or 5 to 10, and L² may be a combination of a specific ring structure(s). Note that in the compounds in the above-described preferred ranges and preferred combinations, q may be 1.

The number-average molecular weight (Mn) of a compound according to the present disclosure is preferably 500 to 20,000, more preferably 600 to 18,000, and still more preferably 700 to 15,000.

When Mn is 500 or larger, the light stability of the surface-treated layer becomes more excellent. When Mn is 20,000 or smaller, the viscosity can be easily adjusted within an appropriate range and the solubility is improved, so that the handling property during the film formation (i.e., during the deposition of the compound) becomes excellent.

### [Composition]

It is sufficient if a composition according to the present disclosure contains a compound according to the present disclosure, and its components other than the compound according to the present disclosure are not limited to any particular components.

That is, it is sufficient if the composition according to the present disclosure contains at least one of a compound represented by Formula (1-1) and a compound represented by Formula (1-2). Note that the composition according to the present disclosure may contain both a compound represented by Formula (1-1) and a compound represented by Formula (1-2).

The composition according to the present disclosure preferably contains a compound according to the present disclosure and a liquid medium. In the case where the composition according to the present disclosure contains a liquid medium, it is sufficient if the liquid medium is in a liquid state. That is, the liquid medium may be a solution or a dispersion liquid.

It is sufficient if the composition according to the present disclosure contains a compound according to the present disclosure, and the composition may also contain impurities such as by-products generated in the process for manufacturing the compound according to the present disclosure.

The content of the compound according to the present disclosure is preferably 0.001 to 40 mass %, more preferably 0.01 to 20 mass %, and still more preferably 0.1 to 10 mass % based on the total amount of the composition according to the present disclosure. In the case where the composition according to the present disclosure is used in a wet coating method, the content of the compound according to the present disclosure is preferably 0.01 to 10 mass %, more preferably 0.02 to 5 mass %, still more preferably 0.03 to 3 mass %, and particularly preferably 0.05 to 2 mass % based on the total amount of the composition according to the present disclosure.

The composition according to the present disclosure may contain only one type of liquid medium, or may contain two or more types of liquid mediums.

The liquid medium is preferably an organic solvent.

Examples of organic solvents include compounds consisting solely of hydrogen atoms and carbon atoms, and compounds consisting solely of hydrogen atoms, carbon atoms, and oxygen atoms. Specifically, examples include hydrocarbon-based organic solvents, ketone-based organic solvents, ether-based organic solvents, ester-based organic solvents, glycol-based organic solvents, and alcohol-based organic solvents. Among them, the organic solvent is preferably an ester-based organic solvent.

Specific examples of hydrocarbon-based organic solvents include pentane, hexane, heptane, octane, hexadecane, isohexane, isooctane, isononane, cycloheptane, cyclohexane, bicyclohexyl, benzene, toluene, ethylbenzene, o-xylene, m-xylene, p-xylene, o-diethylbenzene, m-diethylbenzene, p-diethylbenzene, n-butylbenzene, sec-butylbenzene, and tert-butylbenzene.

Specific examples of ketone-based organic solvents include acetone, methyl ethyl ketone, methyl isobutyl ketone, diisobutyl ketone, cyclohexanone, 2-heptanone, 4-heptanone, 3,5,5-trimethyl-2-cyclohexene-1-one, 3,3,5-trimethylcyclohexanone, and isophorone.

Specific examples of ether-based organic solvents include diethyl ether, cyclopentyl methyl ether, tetrahydrofuran, and 1,4-dioxane. Specific examples of ester-based organic solvents include methyl acetate, ethyl acetate, propyl acetate, isopropyl acetate, butyl acetate, isobutyl acetate, tert-butyl acetate, amyl acetate, isoamyl acetate, ethyl 3-ethoxypropionate, ethyl lactate, ethylene glycol monobutyl ether acetate, diethylene glycol monobutyl ether acetate, propylene glycol monomethyl ether acetate, dipropylene glycol methyl ether acetate, 3-methoxy-3-methylbutyl acetate, 3-methoxybutyl acetate, propylene glycol monomethyl acetate, propylene glycol dimethyl acetate, ethylene glycol monoethyl ether acetate, ethylene glycol monomethyl ether acetate, diethylene glycol monoethyl ether acetate, cyclohexanol acetate, propylene glycol diacetate, propylene glycol monomethyl ether acetate, propylene glycol monomethyl ether propionate, propylene glycol monoethyl ether acetate, propylene glycol monobutyl ether acetate, propylene glycol monopropyl ether acetate, propylene glycol diacetate, dipropylene glycol-methyl ether acetate, 1,3-butylene glycol diacetate, 1,4-butanediol diacetate, 1,3-butylene glycol diacetate, 1,6-hexanediol diacetate, γ-butyrolactone, triacetin, and 2,2,4-trimethyl-1,3-pentanediol monoisobutyrate.

Specific examples of glycol-based organic solvents include ethylene glycol, ethylene glycol monobutyl ether, diethylene glycol monobutyl ether, triethylene glycol monobutyl ether, tetraethylene glycol monobutyl ether, ethylene glycol monohexyl ether, diethylene glycol monohexyl ether, ethylene glycol mono-2-ethylhexyl ether, diethylene glycol mono-2-ethylhexyl ether, propylene glycol monomethyl ether, propylene glycol monoethyl ether, propylene glycol monobutyl ether, propylene glycol monopropyl ether, ethylene glycol monoisopropyl ether, ethylene glycol monoethyl ether, ethylene glycol mono tert-butyl ether, ethylene glycol monopropyl ether, ethylene glycol monomethyl ether, diethylene glycol monoisopropyl ether, diethylene glycol monomethyl ether, dipropylene glycol monoethyl ether, dipropylene glycol monobutyl ether, dipropylene glycol monopropyl ether, dipropylene glycol monomethyl ether, dipropylene glycol monopropyl ether, dipropylene glycol monomethyl ether, tripropylene glycol monobutyl ether, tripropylene glycol monomethyl ether, propylene glycol monophenyl ether, 1,3-butylene glycol, propylene glycol n-propyl ether, propylene glycol n-butyl ether, diethylene glycol monoethyl ether, dipropylene glycol n-propyl ether, dipropylene glycol n-butyl ether, tripropylene glycol methyl ether, tripropylene glycol n-butyl ether, ethylene glycol dimethyl ether, ethylene glycol diethyl ether, diethylene glycol diethyl ether, diethylene glycol dimethyl ether, diethylene glycol dimethyl ether, dipropylene glycol dimethyl ether, diethylene glycol dibutyl ether, tetraethylene glycol dimethyl ether, triethylene glycol dimethyl ether, and polyethylene glycol dimethyl ether.

Specific examples of alcohol-based organic solvents include methanol, ethanol, 1-propanol, isopropyl alcohol, n-butanol, diacetone alcohol, isobutanol, sec-butanol, tert-butanol, pentanol, 3-methyl-1,3-butanediol, 1,3-butanediol, 1,3-butylene glycol, octanediol, 2,4-diethylpentanediol, butylethylpropanediol, 2-methyl-1,3-propanediol, 4-hydroxy-4-methyl-2-pentanone, 2-ethyl-1-hexanol, 3,5,5-trimethyl-1-hexanol, isodecanol, isotridecanol, 3-methoxy-3-methyl-1-butanol, 2-methoxybutanol, 3-methoxybutanol, cyclohexanol, furfuryl alcohol, tetrahydrofurfuryl alcohol, benzyl alcohol, and methylcyclohexanol.

Further, examples of organic solvents include a halogen-based organic solvent, a fluorine-containing organic solvent, a nitrogen-containing compound, a sulfur-containing compound, and a siloxane compound other than the compound according to the present disclosure.

Specific examples of halogen-based organic solvents include dichloromethane, chloroform, carbon tetrachloride, dichloroethane, chlorobenzene, o-chlorotoluene, m-chlorotoluene, p-chlorotoluene, m-dichlorobenzene, and 1,2,3-trichloropropane.

Examples of fluorine-containing organic solvents include polyfluoro aromatic hydrocarbons (e.g., 1,3-bis(trifluoromethyl) benzene); polyfluoro aliphatic hydrocarbons (e.g., C₆F₁₃CH₂CH₃ (e.g., Asahikrin (Registered Trademark) AC-6000 manufactured by AGC Inc.), 1,1,2,2,3,3,4-heptafluorocyclopentane (e.g., Zeorora (Registered Trademark) H manufactured by Zeon Corporation); hydrofluoroethers (HFE) (e.g., alkyl perfluoroalkyl ethers (perfluoroalkyl group and alkyl group may be linear chain or branched) such as perfluoropropyl methyl ether (C₃F₇OCH₃) (e.g., Novec (Registered Trademark) 7000 manufactured by 3M Japan Limited), perfluorobutyl methyl ether (C₄F₉OCH₃) (e.g., Novec (Registered Trademark) 7100 manufactured by 3M Japan Limited), perfluorobutyl ethyl ether (C₄F₉OC₂H₅) (e.g., Novec (Registered Trademark) 7200 manufactured by 3M Japan Limited), and perfluorohexyl methyl ether (C₂F₅CF(OCH₃)C₃F₇) (e.g., Novec (Registered Trademark) 7300 manufactured by 3M Japan Limited), and CF₃CH₂OCF₂CHF₂ (e.g., Asahikrin (Registered Trademark) AE-3000 manufactured by AGC Inc.); and hydrofluoroolefins (HFO) (e.g., 1-chloro-2,3,3-trifluoro-1-propene (HCFO-1233yd) (e.g., Amolea (Registered Trademark) AS-300 manufactured by AGC Inc.)).

Examples of nitrogen-containing compounds include nitrobenzene, acetonitrile, benzonitrile, N,N-dimethylformamide, N,N-dimethylacetamide, N-methylpyrrolidone, and 1,3-dimethyl-2-imidazolidinone.

Examples of sulfur-containing compounds include carbon disulfide and dimethyl sulfoxide.

Examples of siloxane compounds other than the compound according to the present disclosure include hexamethyldisiloxane, hexaethyldisiloxane, octamethyltrisiloxane, octaethyltrisiloxane, hexamethylcyclotrisiloxane, hexaethylcyclotrisiloxane, octamethylcyclotetrasiloxane, octaethylcyclotetrasiloxane, and decamethyltetrasiloxane.

The content of the liquid medium is preferably 60 to 99.999 wt. %, more preferably 80 to 99.99 wt. %, and still more preferably 90 to 99.9 wt. % based on the total amount of the composition according to the present disclosure. In the case where the composition according to the present disclosure is used in a wet coating method, the content of the liquid medium is preferably 90 to 99.99 wt. %, more preferably 95 to 99.98 wt. %, still more preferably 97 to 99.97 wt. %, and particularly preferably 98 to 99.95 wt. % based on the total amount of the composition according to the present disclosure.

In addition to the compound according to the present disclosure and the liquid medium, the composition according to the present disclosure may contain other components in a range in which the effects of the present disclosure are not impaired.

Examples of other components include additives, specifically, catalysts, such as acid catalysts and base catalysts, which accelerate the hydrolysis and the condensation reaction of a reactive silyl group.

For example, an arbitrary suitable acid or base, a transition metal (e.g., Ti, Ni, Sn, Zr, Al or B), a sulfur-containing compound having a non-covalent electron pair in the molecular structure, a nitrogen-containing compound (e.g., a sulfoxide compound, an aliphatic amine compound, an aromatic amine compound, a phosphoric acid amide compound, an amide compound, and a urea compound) can be used as the catalyst.

Examples of acid catalysts include acetic acid, formic acid, trifluoroacetic acid, hydrochloric acid, nitric acid, sulfuric acid, phosphoric acid, sulfonic acid, methanesulfonic acid, and p-toluenesulfonic acid.

Further, examples of base catalysts include ammonia, sodium hydroxide, and potassium hydroxide; and organic amines such as triethylamine and diethylamine.

Further, examples of other components also include metal compounds having hydrolyzable groups (hereinafter also referred to as “specific metal compounds”). When the composition according to the present disclosure contains a specific metal compound, the sliding property and the antifouling property of the surface-treated layer can be further improved. Examples of specific metal compounds include a metal compound represented by one of Formulas (M1) to (M3).

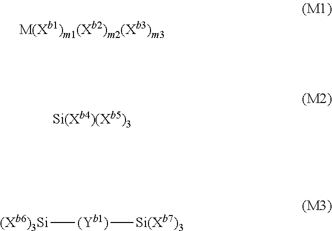

Note that the metal compound represented by Formula (M3) does not include the compound represented by the above-shown Formula (1-2).

In Formula (M1),
M is a trivalent or tetravalent metal atom,
X^{b1} is each independently a hydrolyzable group,
X^{b2} is each independently a siloxane skeleton-containing group,
X^{b3} is each independently a hydrocarbon chain-containing group,
m1 is an integer of 2 to 4,
m2 and m3 are each independently an integer of 0 to 2, and
when M is a trivalent metal atom, m1+m2+m3 is 3, whereas when M is a tetravalent metal atom, m1+m2+m3 is 4.

In Formula (M2).
X^{b4} is a hydrolyzable silane oligomer residue, and
X^{b5} is each independently a hydrolyzable group or an alkyl group having a number of carbon atoms of 1 to 4.

In Formula (M3),
X^{b6} and X^{b7} are each independently a hydrolyzable group or a hydroxyl group, and
Y^{b1} is a divalent organic group.

The metal represented by M in Formula (M1) includes semimetals such as Si and Ge. M is preferably a trivalent metal or a tetravalent metal, more preferably Al, Fe, In, Hf, Si, Ti, Sn, or Zr, still more preferably Al, Si, Ti, or Zr, and particularly preferably Si.

The hydrolyzable group represented by X^{b1} in Formula (M1) is synonymous with the hydrolyzable group represented by L in the above-shown Formula (1-1), and its preferred forms are also the same as those described above.

The siloxane skeleton-containing group represented by X^{b2} has a siloxane unit (—Si—O—), and may be either a linear chain or a branched chain. The siloxane unit is preferably a dialkylsilyloxy group, and examples include a dimethylsilyloxy group and a diethylsilyloxy group. The number of repetitions of the siloxane unit in the siloxane skeleton-containing group is 1 or greater, preferably 1 to 5, more preferably 1 to 4, and still more preferably 1 to 3.

The siloxane skeleton-containing group may contain a divalent hydrocarbon group in a part of the siloxane skeleton. Specifically, an oxygen atom in a part of the siloxane skeleton may be replaced with a divalent hydrocarbon group. Examples of the aforementioned divalent hydrocarbon group include alkylene groups such as a methylene group, an ethylene group, a propylene group, and a butylene group.

A hydrolyzable group, a hydrocarbon group (preferably an alkyl group), or the like may be bonded to a silicon atom at the end of the siloxane skeleton-containing group.

The number of elements of the siloxane skeleton-containing group is preferably 100 or smaller, more preferably 50 or smaller, and still more preferably 30 or smaller. The upper limit of the number of elements is preferably 10 or larger.

The siloxane skeleton-containing group is preferably a group represented by *—(O—Si(CH₃)₂)ₙCH₃, where n is an integer of 1 to 5 and * indicates a part bonded to an adjacent atom.

The hydrocarbon chain-containing group represented by X^{b3} may be a group consisting solely of a hydrocarbon chain or a group having an etheric oxygen atom between carbon atoms of a hydrocarbon chain. The hydrocarbon chain may be a linear chain or a branched chain, and is preferably a linear chain. The hydrocarbon chain may be a saturated hydrocarbon chain or an unsaturated hydrocarbon chain, and is preferably a saturated hydrocarbon chain. The number of carbon atoms of the hydrocarbon chain-containing group is preferably 1 to 3, more preferably 1 to 2, and still more preferably 1. The hydrocarbon chain-containing group is preferably an alkyl group, and more preferably a methyl group, an ethyl group, or a propyl group.
m1 is preferably 3 or 4.

The compound represented by Formula (M1) is preferably a compound represented by one of Formulas (M1-1) to (M1-5) in which M is Si, and more preferably a compound represented by Formula (M1-1). The compound represented by Formula (M1-1) is preferably tetraethoxysilane, tetramethoxysilane, or triethoxymethylsilane.

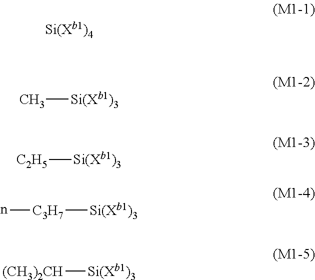

In Formula (M2), the number of silicon atoms contained in the hydrolyzable silane oligomer residue represented by X^{b4} is preferably 3 or greater, more preferably 5 or greater, and still more preferably 7 or greater. The number of silicon atoms is preferably 15 or smaller, more preferably 13 or smaller, and still more preferably 10 or smaller. The hydrolyzable silane oligomer residue may have an alkoxy group that is bonded to a silicon atom.

Examples of the aforementioned alkoxy group include a methoxy group, an ethoxy group, a propoxy group, and a butoxy group. Further, the alkoxy group is preferably a methoxy group or an ethoxy group. The hydrolyzable silane oligomer residue may have one or two or more types of alkoxy groups, and preferably has one type of alkoxy group.

Examples of the hydrolyzable silane oligomer residue include (C₂H₅O)₃Si—(OSi(OC₂H₅)₂)₄O—*. Note that * indicates a part bonded to an adjacent atom.

Examples of the hydrolyzable group represented by X^{b5} in Formula (M2) include those similar to the hydrolyzable group represented by L in the above-shown Formula (1-1), a cyano group, a hydrogen atom, and an allyl group. Further, the hydrolyzable group is preferably an alkoxy group or an isocyanato group. The alkoxy group is preferably an alkoxy group having a number of carbon atoms of 1 to 4.
X^{b5} is preferably a hydrolyzable group.

Examples of the compound represented by Formula (M2) include

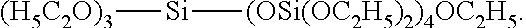

The compound represented by Formula (M3) is a compound having reactive silyl groups at both ends of a divalent organic group, i.e., is bis(silane).

Examples of the hydrolyzable groups represented by X^{b6} and X^{b7} in Formula (M3) include an alkoxy group, an acyloxy group, a ketoxime group, an alkenyloxy group, an amino group, an aminoxy group, an amide group, an isocyanato group, and a halogen atom. Further, the hydrolyzable group is preferably an alkoxy group or an isocyanato group. The alkoxy group is preferably an alkoxy group having a number of carbon atoms of 1 to 4, and still more preferably a methoxy group or an ethoxy group.

In Formula (M3), X^{b6} and X^{b7} may be the same groups as each other or groups different from each other. In view of the availability, X^{b6} and X^{b7} are preferably the same groups as each other.

In Formula (M3), Y^{b1} is a divalent organic group connecting reactive silyl groups at both ends. The number of carbon atoms of Y^{b1} of the divalent organic group is preferably 1 to 8 and more preferably 1 to 3.

Examples of Y^{b1} include an alkylene group, a phenylene group, and an alkylene group having an etheric oxygen atom between carbon atoms. Examples include —CH₂CH₂—, —CH₂CH₂CH₂—, —CH₂CH₂CH₂CH₂—, —CH₂CH₂CH₂CH₂CH₂—, —CH₂CH₂CH₂CH₂CH₂CH₂—, —CH₂C(CH₃)₂CH₂—, —C(CH₃)₂CH₂CH₂C(CH₃)₂—, —CH₂CH₂OCH₂CH₂—, —CH₂CH₂CH₂OCH₂CH₂CH₂—, —CH(CH₃)CH₂OCH₂CH(CH₃)—, and —C₆H₄—.

Examples of the compound represented by Formula (M3) include

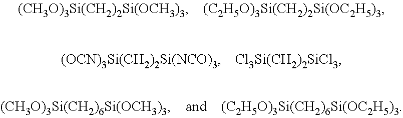

The content of other components which may be contained in the composition according to the present disclosure is preferably 10 mass % or less and more preferably 1 mass % or less based on the total amount of the composition according to the present disclosure. When the composition according to the present disclosure contains a specific metal compound, the content of the specific metal compound is preferably 0.01 to 30 wt. %, more preferably 0.01 to 10 wt. %, and still more preferably 0.05 to 5 wt. % based on the total amount of the composition according to the present disclosure.

The total content (hereinafter also referred to as “solid content concentration”) of the compound according to the present disclosure and the other components is preferably 0.001 to 40 wt. %, more preferably 0.01 to 20 wt. %, and still more preferably 0.1 to 10 wt. % based on the total amount of the composition according to the present disclosure. The solid content concentration of the composition according to the present disclosure is a value calculated from the mass of the composition before being heated and the mass thereof after being heated in a convection-type dryer at 120° C. for 4 hours.

Since the composition according to the present disclosure contains a liquid medium, it is useful for use in which the composition is used for coating, and can be used as a coating liquid.

In addition to the compound according to the present disclosure and the liquid medium, the composition according to the present disclosure may contain a component(s) other than the compound according to the present disclosure and the liquid medium in a range in which the effects of the present disclosure are not impaired. Examples of the other components include known additives such as acid catalysts and basic catalysts that accelerate the hydrolysis and the condensation reaction of the hydrolyzable silyl group.

The content of the other components in the surface treatment agent disclosed herein is preferably 10 mass % or less and more preferably 1 mass % or less.

Examples of other components include a compound represented by the below-shown Formula (5).

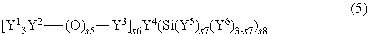

In Formula (5), Y¹ is each independently a hydrocarbon group or a trialkylsilyloxy group,
Y² is Si, Sn, or Ge,
s5 is 0 or 1,
Y³ is each independently an alkylene chain or a polyalkylene oxide chain, or a combination of an alkylene chain and a divalent polysiloxane residue,
Y⁴ is a single bond or a linking group having a valence of s6+s8,
Y⁵ is each independently a hydrocarbon group,
Y⁶ is each independently a hydrolyzable group or a hydroxyl group,
s7 is each independently an integer of 0 to 2, and
s6 and s8 are each independently an integer of 1 or greater.

The compound represented by Formula (5) is preferably a compound in which Y³ is an alkylene chain or a polyalkylene oxide chain.

Specific examples of the compound represented by Formula (5) include compounds shown below. α in the formula is preferably 9 to 50, more preferably 11 to 30, and particularly preferably 11 to 25.

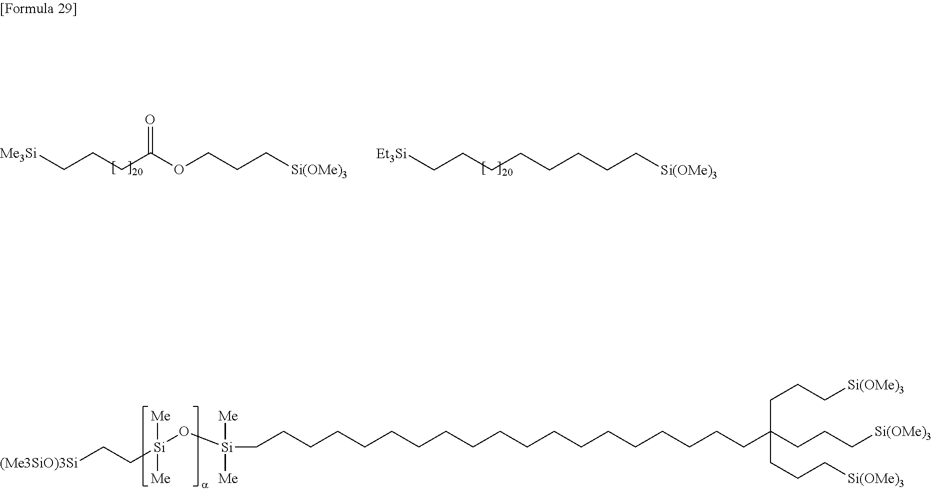

When the other component(s) in the surface treatment agent disclosed herein is the compound represented by Formula (5), the content of the compound represented by Formula (5) is preferably 50 mass % or less, and more preferably 40 mass % or less.

### [Surface Treatment Agent]

In an embodiment, a surface treatment agent according to the present disclosure contains a compound according to the present disclosure. That is, it is sufficient if the surface treatment agent according to the present disclosure contains at least one of a compound represented by Formula (1-1) and a compound represented by Formula (1-2). Note that the surface treatment agent according to the present disclosure may comprise both a compound represented by Formula (1-1) and a compound represented by Formula (1-2).

Further, a surface treatment agent according to the present disclosure may contain a compound according to the present disclosure and a liquid medium. A surface treatment agent according to the present disclosure may be a composition according to the present disclosure. Preferred embodiments of the liquid medium contained in the surface treatment agent according to the present disclosure are similar to those of the liquid medium contained in the composition according to the present disclosure.

### [Article]

In an embodiment, an article according to the present disclosure includes a substrate and a surface-treated layer which is disposed on the substrate and of which the surface is treated with a surface treatment agent according to the present disclosure.

The surface-treated layer may be formed on a part of the surface of the substrate or over the entire surface of the substrate. The surface-treated layer may be spread in the form of a film on the surface of the substrate or scattered in the form of dots.

In the surface-treated layer, the compound according to the present disclosure is contained therein in a state in which the hydrolysis of some or all of reactive silyl groups ((Si(R)ₙL₃₋ₙ)) has progressed and the dehydration condensation reaction of silanol groups has progressed.

The thickness of the surface-treated layer is preferably 1 to 100 nm and more preferably 1 to 50 nm. When the thickness of the surface-treated layer is 1 nm or larger, the effects of the surface treatment are likely to be obtained satisfactorily. When the thickness of the surface-treated layer is 100 nm or smaller, the usage efficiency is high. The thickness of the surface-treated layer can be calculated from the oscillation cycle of the interference pattern of the reflected X-ray, which is obtained by an X-ray reflectivity method using an X-ray diffractometer for thin film analysis (Product name: ATX-G, manufactured by Rigaku Corporation).

The type of the substrate is not limited to any particular types, and examples include a substrate which is required to have water repellency. Examples of the substrate include a substrate which may be used while touching it with another article (e.g., a stylus) or a human hand or fingers; a substrate which may be held by a human hand or fingers during the operation; and a substrate which may be placed on another article (e.g., a mounting table).

Examples of the material of the substrate include metals, resins, glass, sapphire, ceramics, semiconductors, stones, fibers, nonwoven fabric, paper, wood, fur, natural leather, artificial leather, ceramics, and composite materials thereof. The glass may be one that is chemically reinforced.

Examples of substrates including building materials, decorative building materials, interior goods, transportation apparatuses (e.g., automobiles), signboards, bulletin boards, drinking containers, tableware, water tanks, ornamental apparatuses (e.g., frames and boxes), laboratory apparatuses, furniture, textile products, and packaging containers; glass or resins used for art, sports, games and the like; glass or resins used for exterior parts (excluding display parts) of apparatuses such as mobile phones (e.g., smartphones), mobile information terminals, game machines, and remote controllers. The shape of the substrate may be plate-like or film-like.

The substrate is preferably a substrate for a touch panel, a substrate for a display, or a lens for eyeglasses, and particularly preferably a substrate for a touch panel. The material of a substrate for a touch panel is preferably glass or a transparent resin.

The substrate may be a substrate of which a surface treatment such as a corona discharge treatment, a plasma treatment, a plasma graft polymerization treatment, or the like has been performed on one or both of the surfaces. The substrate subjected to the surface treatment has a more excellent adhesive property for the surface-treated layer, and the light stability of the surface-treated layer is further improved. Therefore, it is preferred to perform a surface treatment on the surface of the substrate on the side which is brought into contact with the surface-treated layer. Further, in the case where an underlayer (which will be described later) is provided, the substrate subjected to the surface treatment has a more excellent adhesive property for the underlayer, and the light stability of the surface-treated layer is further improved. Therefore, in the case where an underlayer is provided, it is preferred to perform a surface treatment on the surface of the substrate on the side which is brought into contact with the underlayer.

The surface-treated layer may be directly disposed on the surface of the substrate, or an underlayer may be provided between the substrate and the surface-treated layer. In order to further improve the light stability of the surface-treated layer, an article according to the present disclosure preferably includes a substrate, an underlayer disposed on the substrate, and a surface-treated layer which is disposed on the underlayer and of which the surface is treated with a surface treatment agent according to the present disclosure.

The underlayer is preferably a layer comprising an oxide comprising silicon and at least one specific element selected from the group consisting of Group 1 elements, Group 2 elements, Group 4 elements, Group 5 elements, Group 13 elements, and Group 15 elements in the periodic table.

Group 1 elements in the periodic table (hereinafter also referred to simply as “Group 1 elements”) mean lithium, sodium, potassium, rubidium, and cesium. Group 1 elements are preferably lithium, sodium, and potassium, and more preferably sodium and potassium because the surface-treated layer can be formed more uniformly on the underlayer without defects or because variations in the composition of the underlayer among samples are more suppressed. The underlayer may contain two or more Group 1 elements.

Group 2 elements in the periodic table (hereinafter also referred to simply as “Group 2 elements”) mean beryllium, magnesium, calcium, strontium, and barium. Group 2 elements are preferably magnesium, calcium, and barium, and more preferably magnesium and calcium because the surface-treated layer can be formed more uniformly on the underlayer without defects or because variations in the composition of the underlayer among samples are more suppressed. The underlayer may contain two or more Group 2 elements.

Group 4 elements in the periodic table (hereinafter also referred to simply as “Group 4 elements”) mean titanium, zirconium, and hafnium. Group 4 elements are preferably titanium and zirconium, and more preferably titanium because the surface-treated layer can be formed more uniformly on the underlayer without defects or because variations in the composition of the underlayer among samples are more suppressed. The underlayer may contain two or more Group 4 elements.

Group 5 elements in the periodic table (hereinafter also referred to simply as “Group 5 elements”) mean vanadium, niobium, and tantalum. Group 5 elements are particularly preferably vanadium because the light stability of the surface-treated layer becomes more excellent. The underlayer may contain two or more Group 5 elements.

Group 13 elements in the periodic table (hereinafter also referred to simply as “Group 13 elements”) mean boron, aluminum, gallium, and indium. Group 13 elements are preferably boron, aluminum, and gallium, and more preferably boron and aluminum because the surface-treated layer can be formed more uniformly on the underlayer without defects or because variations in the composition of the underlayer among samples are more suppressed. The underlayer may contain two or more Group 13 elements.

Group 15 elements in the periodic table (hereinafter also referred to simply as “Group 15 elements”) mean nitrogen, phosphorus, arsenic, antimony, and bismuth. Group 15 elements are preferably phosphorus, antimony, and bismuth, and more preferably phosphorus and bismuth because the surface-treated layer can be formed more uniformly on the underlayer without defects or because variations in the composition of the underlayer among samples are more suppressed. The underlayer may contain two or more Group 15 elements.

The specific element contained in the underlayer is preferably a Group 1 element, a Group 2 element, and a Group 13 element, more preferably a Group 1 element and a Group 2 element, and still more preferably a Group 1 element because the light stability of the surface-treated layer becomes more excellent.

Only one element or two or more elements may be contained as the specific element(s).

The oxide contained in the underlayer may be a mixture of oxides each comprising only one of the aforementioned elements (silicon and specific element) (e.g., a mixture of silicon oxide and an oxide of a specific element), a composite oxide comprising two or more of the aforementioned elements, or a mixture of an oxide comprising only one of the aforementioned elements and a composite oxide.

The ratio of the total molarity of the specific element in the underlayer to the molarity of silicon in the underlayer (specific element/silicon) is preferably 0.02 to 2.90, more preferably 0.10 to 2.00, and still more preferably 0.20 to 1.80 because the light stability of the surface-treated layer becomes more excellent.

The molarity (mol %) of each element in the underlayer can be measured, for example, by a depth-direction analysis by X-ray photoelectron spectroscopy (XPS) using ion sputtering.

The underlayer may be a single layer or may consist of a plurality of layer. The underlayer may have an uneven surface(s).

The thickness of the underlayer is preferably 1 to 100 nm, more preferably 1 to 50 nm, and still more preferably 2 to 20 nm. When the thickness of the underlayer is equal to or larger than the aforementioned lower limit value, the adhesive property of the surface-treated layer by the underlayer is further improved, so that the light stability of the surface-treated layer becomes more excellent. When the thickness of the underlayer is equal to or smaller than the aforementioned upper limit value, the light stability of the underlayer itself becomes excellent.

The thickness of the underlayer is measured by observing the cross section of the underlayer by a transmission electron microscope (TEM).

The underlayer can be formed, for example, by a vapor-deposition method using a vapor-deposition material or a wet coating method.

The vapor-deposition material used in the vapor-deposition method preferably contains silicon and an oxide comprising a specific element.

Specific examples of the form of the vapor-deposition material include a powder, a molten material, a sintered compact, granules, and a crushed material. Further, a molten material, a sintered compact, and granules are preferred in view of the handling property.

Note that the molten material means a solid material obtained by melting a powder of a vapor-deposition material at a high temperature, and then cooling and solidifying the molten vapor-deposition material. The sintered compact means a solid material obtained by firing a powder of a vapor-deposition material. Further, if necessary, instead of the powder of the vapor-deposition material, a molded compact formed by pressing the powder may be used. The granules means a solid material obtained by mixing and kneading a powder of a vapor-deposition material and a liquid medium (e.g., water or an organic solvent) and thereby obtaining particles thereof, and then drying the obtained particles.

The vapor-deposition material can be manufactured, for example, by the following methods.
A method in which a powder of a vapor-deposition material is obtained by mixing a powder of silicon oxide with a powder of an oxide of a specific element.
A method in which granules of a vapor-deposition material is obtained by, after obtaining particles by mixing and kneading a powder of the aforementioned vapor-deposition material and water, drying the obtained particles.
A method in which a sintered compact is obtained by drying a mixture obtained by mixing a powder comprising silicon (e.g., a powder made of silicon oxide, silica sand, or silica gel), a powder comprising a specific element (e.g., a powder of an oxide of a specific element, a carbonate, a sulfate, a nitrate, an oxalate, or a hydroxide), and water, and then firing the dried mixture or a molded article obtained by press-molding the dried mixture.
A method in which a molten material is obtained by melting a mixture obtained by mixing a powder comprising silicon (e.g., a powder made of silicon oxide, silica sand, or silica gel), a powder comprising a specific element (e.g., a powder of an oxide of a specific element, a carbonate, a sulfate, a nitrate, an oxalate, or a hydroxide), and water at a high temperature, and then cooling and solidifying the molten substance.

Specific examples of the vapor-deposition method using a vapor-deposition material include a vacuum vapor-deposition method. The vacuum vapor-deposition method is a method in which a vapor-deposition material is evaporated in a vacuum chamber and deposited on the surface of a substrate.

The temperature during the vapor-deposition (e.g., in the case where a vacuum deposition apparatus is used, the temperature of a boat in which the deposition material is disposed) is preferably 100 to 3,000° C. and more preferably 500 to 3,000° C.

The pressure during the vapor-deposition (e.g., in the case where a vacuum deposition apparatus is used, the pressure in a chamber in which the deposition material is disposed) is preferably 1 Pa or lower and more preferably 0.1 Pa or lower.

When an underlayer is formed by using a vapor-deposition material, one vapor-deposition material may be used, or two or more vapor-deposition materials comprising different elements may be used.

Specific examples of the method for evaporating a vapor-deposition material include a resistive heating method in which a vapor-deposition material is melted and evaporated on a resistive heating boat made of a high melting-point metal, and an electron gun method in which a vapor-deposition material is irradiated with an electron beam and thereby directly heated, so that its surface is melted and evaporated. As the method for evaporating a vapor-deposition material, the electron gun method is preferred because since the material can be locally heated, even a material having a high melting point can be evaporated, and since an area that is not irradiated with the electron beam is kept at a low temperature, there is no risk of reaction with the container nor risk of contamination by impurities.

As the method for evaporating a vapor-deposition material, a plurality of boats may be used, or the whole vapor-deposition materials may be put in a single boat. The vapor-deposition method may be co-vapor deposition or alternating vapor deposition. Specific examples include an example in which silica and a specific source are mixed and used in the same boat, an example in which co-vapor deposition is performed in a state in which silica and a specific element source put in separate boats, and an example in which alternating vapor deposition is performed in a similar manner, i.e., in a state in which silica and a specific element source are put in separate boats. The conditions for the vapor deposition, the order, and the like are selected as appropriate according to the structure of the underlayer.

In the wet coating method, it is preferred to form an underlayer on a substrate by a wet coating method using a coating liquid comprising a compound comprising silicon, a compound comprising a specific element, and a liquid medium.

Specific examples of silicon compounds include silicon oxide, silicic acid, partial condensate of silicic acid, alkoxysilane, and partial hydrolysis condensate of alkoxysilane.

Specific examples of compounds comprising a specific element include oxides of the specific element, alkoxides of the specific element, carbonates of the specific element, sulfates of the specific element, nitrates of the specific element, oxalates of the specific element, and hydroxides of the specific element.

Examples of liquid mediums include those similar to liquid mediums contained in the composition according to the present disclosure.

The content of the liquid medium is preferably 0.01 to 20 mass % and more preferably 0.1 to 10 mass % based on the total amount of the coating liquid used for the formation of the underlayer.

Specific examples of the wet coating method for forming an underlayer include a spin coating method, a wipe coating method, a spray coating method, a squeegee coating method, a dip coating method, a die coating method, an ink jet method, a flow coating method, a roll coating method, a casting method, a Langmuir-Blodgett method, and a gravure coating method.

After the substrate or the like is wet-coated with the coating liquid, the coating is preferably dried. The drying temperature of the coating is preferably 20 to 200° C. and more preferably 80 to 160° C.

The article according to the present disclosure may be an optical material including a surface-treated layer as the outermost layer.

Examples of preferred optical materials include a wide variety of optical materials in addition to optical materials related to displays or the like.

Examples of optical materials include a cathode ray tube (CRT; e.g., a computer monitor), a display such as a liquid crystal display, a plasma display, an organic EL display, an inorganic thin film EL dot matrix display, a rear projection-type display, a vacuum fluorescent display (VFD), and a field emission display (FED), a protective plate for such a display, and those in which an antireflection film treatment is performed on their surfaces.

The article according to the present disclosure is preferably an optical member. Examples of optical members include a car navigation system, a mobile phone, a smartphone, a digital camera, a digital video camera, a PDA, a portable audio player, a car audio system, a game apparatus, a lens for eyeglasses, a camera lens, a lens filter, sunglasses, a medical apparatus such as a gastroscope, a copying machine, a PC, a display (e.g., a liquid crystal display, an organic EL display, a plasma display, and a touch panel display), a touch panel, a protective film, and an antireflection film.

Further, examples of optical members include a front protective plate for a display such as a PDP and an LCD, an antireflection plate, a polarizing plate, and an antiglare plate; a disk surface of an optical disk such as a Blu-ray (Blu-ray (Registered Trademark)) disk, a DVD disk, a CD-R, and an MO; an optical fiber; and a display surface of a clock or a watch.

In particular, the article according to the present disclosure is preferably a display or a touch panel.

The article according to the present disclosure may be a medical apparatus or a medical material. Further, the article according to the present disclosure may also be an automobile interior or exterior member. Examples of exterior members include a window, a light cover, and an external camera cover. Examples of interior members include an instrument panel cover, a navigation system touch panel, and a decorative interior member.

When the article according to the present disclosure is an optical member, the material constituting the surface of the substrate is a member for an optical member, e.g., glass or transparent plastic. Further, when the article according to the present disclosure is an optical member, a functional layer such as a hard coat layer or an antireflection layer may be formed on the surface (outermost layer) of the substrate. The antireflection layer may be either a single-layer antireflection layer or a multi-layer antireflection layer.

Examples of inorganic substances that can be used for the antireflection layer include SiO₂, SiO, ZrO₂, TiO₂, TiO, Ti₂O₃, Ti₂O₅, Al₂O₃, Ta₂O₅, Ta₃O₅, Nb₂O₅, HfO₂, Si₃N₄, CeO₂, MgO, Y₂O₃, SnO₂, MgF₂, and WO₃. These inorganic substances may be used alone or in combination (e.g., as a mixture) of two or more of them. In the case of the multi-layer antireflection layer, it is preferred to use SiO₂ and/or SiO in the outermost layer. When the article according to the present disclosure is an optical glass component for a touch panel, a thin film using a transparent electrode, e.g., indium tin oxide (ITO), indium zinc oxide, or the like, may be provided on a part of the surface of the substrate (glass). Further, the substrate may also include an insulating layer, an adhesive layer, a protective layer, a decorative frame layer (I—CON), an atomization film layer, a hard coating film layer, a polarizing film, a phase difference film, a liquid crystal display module, or the like according to its specific specifications.

### [Method for Manufacturing Article]

A method for manufacturing an article according to the present disclosure is, for example, a method for manufacturing an article including a surface-treated layer formed on a substrate by performing a surface treatment on the substrate by using a surface treatment agent according to the present disclosure. Examples of surface treatments include a dry coating method and a wet coating method.

Examples of dry coating methods include techniques such as vacuum vapor deposition, CVD, and sputtering. As the dry coating method, a vacuum vapor-deposition method is preferred in order to suppress the decomposition of the compound and in view of the simplicity of the apparatus. During the vacuum deposition, a pellet-like substance obtained by impregnating a porous material made of a metal such as iron or steel with a compound according to the present disclosure may be used. A pellet-like substance, which is obtained by impregnating a porous material made of a metal such as iron or steel with a composition comprising a compound according to the present disclosure and a liquid medium, and drying the liquid medium, may be used.

Examples of wet coating methods include a spin coating method, a wipe coating method, a spray coating method, a squeegee coating method, a dip coating method, a die coating method, an ink jet method, a flow coating method, a roll coating method, a casting method, a Langmuir-Blodgett method, and a gravure coating method.

In order to improve the light stability of the surface-treated layer, when necessary, an operation for accelerating the reaction between the compound according to the present disclosure and the substrate may be performed. Examples of such operations include heating, humidification, and irradiation with light.

For example, it is possible to accelerate, by heating a substrate on which a surface-treated layer is formed in an atmosphere comprising moisture, the reaction such as a hydrolysis reaction of a hydrolyzable group, a reaction between a hydroxyl group or the like and a silanol group on the surface of the substrate, and formation of a siloxane bond by a condensation reaction of a silanol group.

After the surface treatment, compounds which are contained in the surface-treated layer and are not chemically bonded to other compounds nor the substrate may be removed as required. Examples of removal methods include a method in which a solvent is poured over the surface-treated layer, and a method in which the surface-treated layer or the like is wiped with a cloth impregnated with a solvent.

### EXAMPLES

The present invention will be described hereinafter in a more detailed manner by using examples, but the present invention is not limited to these examples.

### Example 1: Compound (D)

### Step 1-1: Synthesis of Compound (A)

2,3,4,5,6-pentafluorophenol (6.8 g), THF (tetrahydrofuran, 42 mL), and triethylamine (5.1 g) were added to a 100 mL flask under a nitrogen atmosphere, and the mixture was stirred at 25° C. Next, 3-cyclopentene-1-carboxylic acid chloride (5.0 g) was dropwise, and the mixture was stirred for 1 hour. 7.9 g of a compound (A) was obtained by filtering the reaction solution, removing the solvent and low-boiling components by distillation under a reduced pressure, and performing flash column chromatography (developing solvent: hexane/ethyl acetate) using silica gel. The structure of the compound (A) was confirmed from NMR data shown below.

¹H-NMR (400 MHz, CDCl₃): δ5.72 (s, 2H), 3.45 (m, 1H), 2.85 (m, 4H).

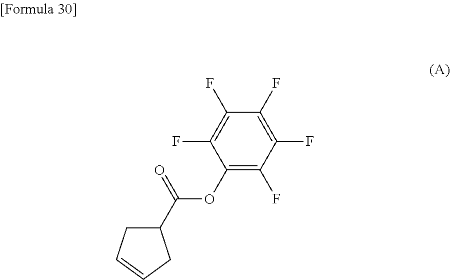 [SMILES: O=C(Oc1c(F)c(F)c(F)c(F)c1F)C1CC=CC1]

### Step 1-2: Synthesis of Compound (B)

The compound (A) (5.6 g), THF (5.0 mL), and chlorodimethylsilane (2.3 g) were added to a 200 mL flask under a nitrogen atmosphere, and the mixture was stirred at 25° C. Next, a xylene solution of platinum/1,3-divinyl-1,1,3,3-tetramethyldisiloxane complex (platinum content: 3 mass %, 0.10 mL) was added to the resultant solution, and the mixture was stirred at 70° C. for 2 hours. 7.2 g of a compound (B) was obtained by removing the solvent and low-boiling components from the reaction solution by distillation under a reduced pressure. The structure of the compound (B) was confirmed from NMR data shown below.

¹H-NMR (400 MHz, CDCl₃): δ3.10-2.50 (m, 1H), 2.30-1.20 (m, 7H), 0.43- (−0.08) (m, 6H).

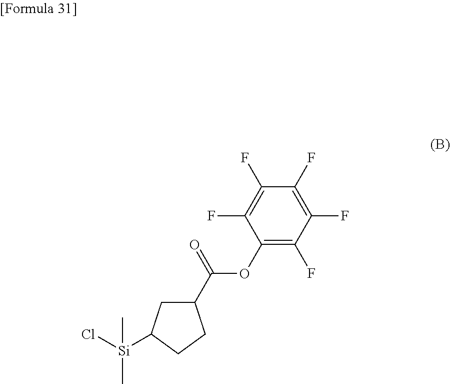 [SMILES: C[Si](C)(Cl)C1CCC(C(=O)Oc2c(F)c(F)c(F)c(F)c2F)C1]

### Step 1-3: Synthesis of Compound (C)

Trimethylsilanol (0.19 g) and THF (5 mL) were added to a 100 mL three-necked flask under a nitrogen atmosphere, and the mixture was stirred at 25° C. Next, the resultant solution was cooled to 0° C., and a hexane solution of n-BuLi (n-butyllithium) (1.6M, 0.9 mL) was dropped to the cooled solution. Next, a THF solution of hexamethylcyclotrisiloxane (1.2M, 1 mL) was dropped, and a THF solution of hexamethylcyclotrisiloxane (1.2M, 9 mL) was further dropped. Then, the mixture was stirred for 2 hours. Next, the compound (B) (1.28 g) was added, and the mixture was stirred for 1 hour. Next, 2,2-diallylpenta-4-ene-1-amine (0.95 g) was further added, and the mixture was stirred for 1 hour. Hexane and ion-exchanged water were successively added to the reaction solution. Then, the resultant solution was separated, and an organic phase was separated therefrom. The solvent and low-boiling components were removed from the organic phase by distillation under a reduced pressure. Then, 1.2 g of a compound (C) was obtained by performing flash column chromatography (developing solvent: hexane/ethyl acetate) using silica gel. The structure of the compound (C) was confirmed from NMR data shown below. The average value of n in the compound (C) was 18.

¹H-NMR (400 MHz, CDCl₃): δ5.80 (ddt, J=17.7, 10.6, 7.4 Hz, 3H), 5.15-4.90 (m, 6H), 3.12 (d, J=6.3 Hz, 2H), 3.10-2.50 (m, 1H), 2.30-1.20 (m 7H), 0.43- (−0.08) (m, 129H).

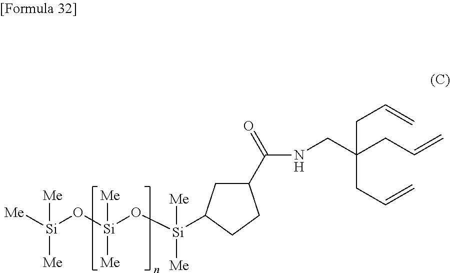

### Step 1-4: Synthesis of Compound (D)

Dichloromethane (10 g) and the compound (C) (0.80 g) were added to a 100 mL flask, and the mixture was stirred at 25° C. Next, a toluene solution of platinum/1,3-divinyl-1,1,3,3-tetramethyldisiloxane complex (platinum content: 3 mass %, 4.1 mg), aniline (2.6 mg), and trimethoxysilane (0.40 g) were added, and the mixture was stirred at 25° C. for 2 hours. 0.75 g of a compound (D) was obtained by removing the solvent from the reaction solution by distillation under a reduced pressure. The structure of the compound (D) was confirmed from NMR data shown below. The average value of n in the compound (D) was 18.

¹H-NMR (400 MHz, CDCl₃): δ5.66 (d, J=6.4 Hz, 1H), 3.49 (s, 27H), 3.46 (d, J=29.0 Hz, 2H), 3.10-2.50 (m, 1H), 2.30-1.20 (m, 16H), 0.40 (m, 6H), 0.35- (−0.08) (m, 129H).

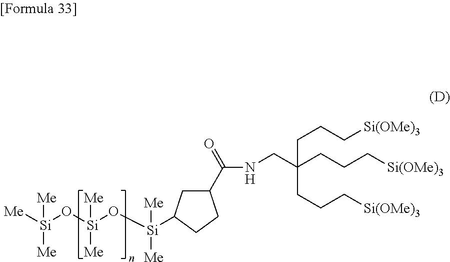

### Example 2: Compound (K)

### Step 2-1: Synthesis of Compound (E)

DMF (N,N-dimethylformamide, 100 mL), 3-hydroxy-4-adamantane carboxylic acid (5.0 g), potassium carbonate (10 g), and benzyl bromide (10 g) were added to a 300 mL flask, and the mixture was stirred at 50° C. for 5 hours. Hexane and ion-exchanged water were added subsequently to the reaction solution. Then, the resultant solution was separated, and an organic phase was separated therefrom. The solvent and low-boiling components were removed from the organic phase by distillation under a reduced pressure. Then, 4.0 g of a compound (E) was obtained by performing flash column chromatography (developing solvent: hexane/ethyl acetate) using silica gel. The structure of the compound (E) was confirmed from NMR data shown below.

¹H-NMR (400 MHz, CDCl₃): δ 7.38-7.26 (m, 5H), 5.13 (s, 2H), 3.67 (s, 1H), 2.65 (m, 1H), 2.36 (m, 1H), 2.10-1.60 (m, 12H).

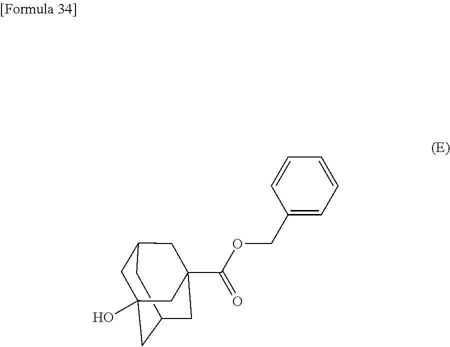 [SMILES: O=C(OCc1ccccc1)C12CC3CC(CC(O)(C3)C1)C2]

### Step 2-2: Synthesis of Compound (F)

DMF (100 mL), the compound (E) (5.0 g), potassium carbonate (10 g), and allyl bromide (5 g) were added to a 300 mL flask, and the mixture was stirred at 100° C. for 5 hours. Next, hexane and ion-exchanged water were added subsequently to the reaction solution. Then, the resultant solution was separated, and an organic phase was separated therefrom. The solvent and low-boiling components were removed from the organic phase by distillation under a reduced pressure. Then, 3.2 g of a compound (F) was obtained by performing flash column chromatography (developing solvent: hexane/ethyl acetate) using silica gel. The structure of the compound (F) was confirmed from NMR data shown below.

¹H-NMR (400 MHz, CDCl₃): δ 7.38-7.26 (m, 5H), 5.84 (m, 1H), 5.30 (m, 2H), 5.13 (s, 2H), 4.13 (m, 2H), 2.65 (m, 1H), 2.36 (m, 1H), 2.10-1.60 (m, 12H).

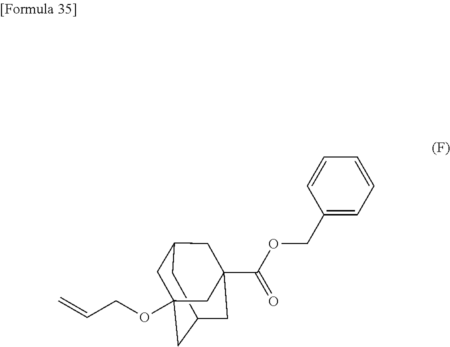 [SMILES: C=CCOC12CC3CC(C1)CC(C(=O)OCc1ccccc1)(C3)C2]

### Step 2-3: Synthesis of Compound (G)

The compound (F) (3.0 g), THF (5.0 mL), and chlorodimethylsilane (2.3 g) were added to a 200 mL flask under a nitrogen atmosphere, and the mixture was stirred at 25° C. A xylene solution of platinum/1,3-divinyl-1,1,3,3-tetramethyldisiloxane complex (platinum content: 3 mass %, 0.10 mL) was added, and the mixture was stirred at 25° C. for 2 hours. 3.1 g of a compound (G) was obtained by removing the solvent and low-boiling components from the reaction solution by distillation under a reduced pressure. The structure of the compound (G) was confirmed from NMR data shown below.

¹H-NMR (400 MHz, CDCl₃): δ 7.38-7.26 (m, 5H), 5.13 (s, 2H), 3.42 (m, 2H), 2.65 (m, 1H), 2.36 (m, 1H), 2.10-1.60 (m, 14H), 0.80 (m, 2H).

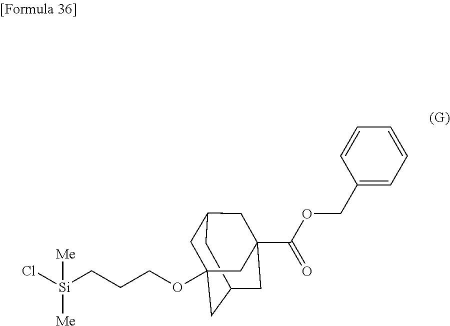 [SMILES: C[Si](C)(Cl)CCCOC12CC3CC(C1)CC(C(=O)OCc1ccccc1)(C3)C2]

### Step 2-4: Synthesis of Compound (H)

Trimethylsilanol (0.19 g) and THF (5 mL) were added to a 100 mL three-necked flask under a nitrogen atmosphere, and the mixture was stirred at 25° C. Next, the mixture was cooled to 0° C., and a hexane solution of n-BuLi (1.6M, 0.9 mL) was dropped. Next, a THF solution of hexamethylcyclotrisiloxane (1.2M, 1 mL) was dropped, and a THF solution of hexamethylcyclotrisiloxane (1.2M, 9 mL) was further dropped. Then, the mixture was stirred for 2 hours. Next, the compound (G) (1.28 g) was added, and the mixture was stirred at 25° C. for 1 hour. Hexane and ion-exchanged water were added subsequently to the reaction solution. Then, the resultant solution was separated, and an organic phase was separated therefrom. The solvent and low-boiling components were removed from the organic phase by distillation under a reduced pressure. Then, 1.2 g of a compound (H) was obtained by performing flash column chromatography (developing solvent: hexane/ethyl acetate) using silica gel. The structure of the compound (H) was confirmed from NMR data shown below. The average value of n in the compound (H) was 18.

¹H-NMR (400 MHz, CDCl₃): δ 7.38-7.26 (m, 5H), 5.13 (s, 2H), 3.42 (m, 2H), 2.65 (m, 1H), 2.36 (m, 1H), 2.10-1.60 (m, 14H), 0.42 (m, 2H), 0.35- (−0.08) (m, 129H).

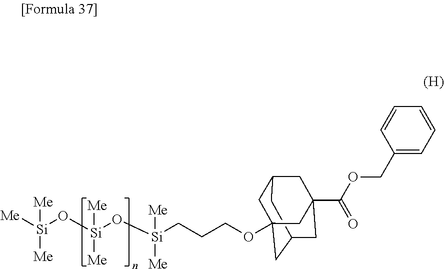

### Step 2-5: Synthesis of Compound (I)

The compound (H) (3.2 g), 10% palladium-carbon (comprising water in 50%, 320 mg), and THF (15 mL) were added to a 100 mL flask under a hydrogen atmosphere, and the mixture was stirred at 25° C. for 4 hours. 2.9 g of a compound (I) was obtained by filtering out insoluble substances from the reaction solution and removing the solvent of the filtrate by distillation under a reduced pressure. The structure of the compound (I) was confirmed from NMR data shown below. The average value of n in the compound (I) was 18.

¹H-NMR (400 MHz, CDCl₃): δ 3.42 (m, 2H), 2.65 (m, 1H), 2.36 (m, 1H), 2.10-1.60 (m, 14H), 0.42 (m, 2H), 0.35- (−0.08)(m, 129H).

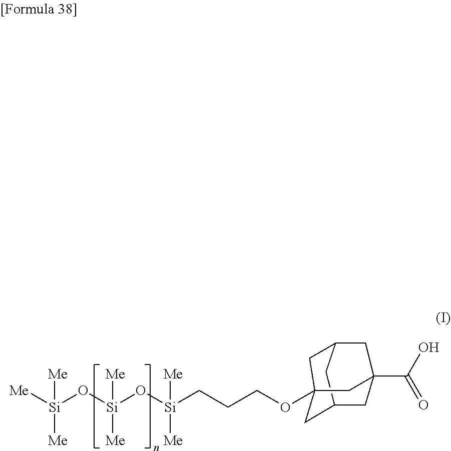

### Step 2-6: Synthesis of Compound (J)

The compound (I) (1.5 g), 2,2-diallylpenta-4-ene-1-amine (660 mg), triethylamine (0.70 mL), and THF (30 mL) were added to a 100 mL flask, and the mixture was stirred at 25° C. Next, an ethyl-acetate solution of 1-propanophosphonic anhydride (50 mass %, 1.5 mL) was added, and the mixture was stirred at 25° C. for 16 hours. Ion-exchanged water was added subsequently to the reaction solution, and then an organic phase was extracted by adding ethyl acetate. The organic phase was washed with 2N hydrochloric acid, saturated sodium-bicarbonate water, and saturated saline, and dried with magnesium sulfate. Next, 1.3 g of a compound (J) was obtained by removing the solvent and low-boiling components from the organic phase by distillation under a reduced pressure and performing flash column chromatography (developing solvent: hexane/ethyl acetate) using silica gel. The structure of the compound (J) was confirmed from NMR data shown below. The average value of n in the compound (J) was 18.

¹H-NMR (400 MHz, CDCl₃): δ 5.81 (ddt, J=16.9, 10.2, 6.7 Hz, 2H), 5.42-5.27 (m, 1H), 5.05-4.85 (m, 4H), 3.42 (m, 2H), 3.19 (m, 2H), 2.65 (m, 1H), 2.36 (m, 1H), 2.10-1.60 (m, 14H), 0.42 (m, 2H), 0.35- (−0.08) (m, 129H).

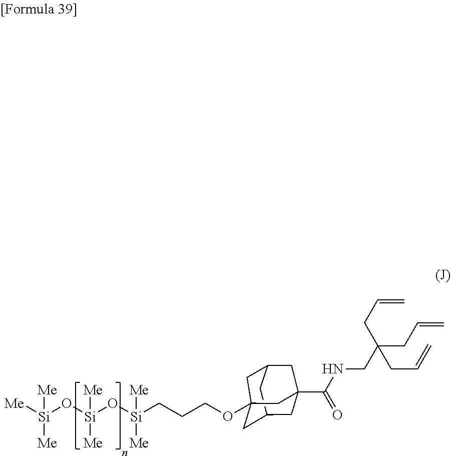

### Step 2-7: Synthesis of Compound (K)

Dichloromethane (10 g) and the compound (J) (0.80 g) were added to a 100 mL flask, and the mixture was stirred at 25° C. A toluene solution of platinum/1,3-divinyl-1,1,3,3-tetramethyldisiloxane complex (platinum content: 3 mass %, 4.1 mg), aniline (2.6 mg), and trimethoxysilane (0.40 g) were added, and the mixture was stirred at 25° C. for 2 hours. 0.75 g of a compound (k) was obtained by removing the solvent from the reaction solution by distillation under a reduced pressure. The structure of the compound (K) was confirmed from NMR data shown below. The average value of n in the compound (K) was 18.

¹H-NMR (400 MHz, CDCl₃): δ 5.66 (s, 1H), 3.42 (m, 2H), 3.19 (m, 2H), 2.65 (m, 1H), 2.36 (m, 1H), 2.10-1.60 (m, 23H), 0.42 (m, 2H), 0.40 (m, 6H), 0.35- (−0.08) (m, 129H).

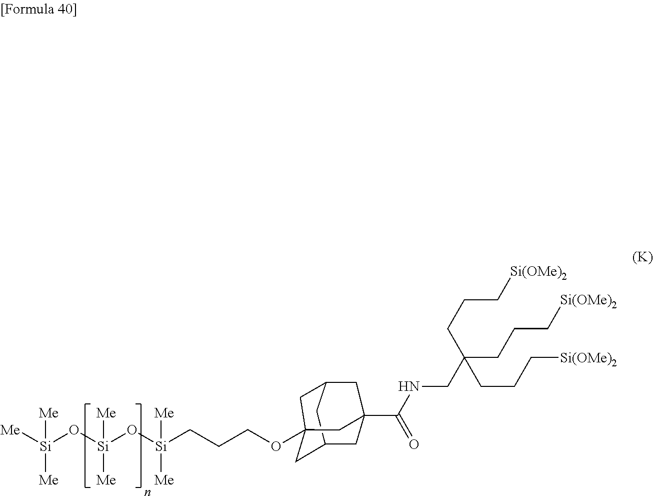

### Example 3: Compound (O)

### Step 3-1: Synthesis of Compound (L)

5-Norbornene-2,3-dicarboxylic anhydride (3.0 g), THF (5.0 mL), and chlorodimethylsilane (2.3 g) were added to a 200 mL flask under a nitrogen atmosphere, and the mixture was stirred at 25° C. Next, a xylene solution of platinum/1,3-divinyl-1,1,3,3-tetramethyldisiloxane complex (platinum content: 3 mass %, 0.10 mL) was added, and the mixture was stirred at 70° C. for 2 hours. 3.1 g of a compound (L) was obtained by removing the solvent and low-boiling components from the reaction solution by distillation under a reduced pressure. The structure of the compound (L) was confirmed from NMR data shown below.

¹H-NMR (400 MHz, CDCl₃): δ 3.75 (m, 2H), 3.15 (m, 1H), 2.91 (m, 1H), 2.21-1.58 (m, 5H), 0.43- (−0.08) (m, 6H).

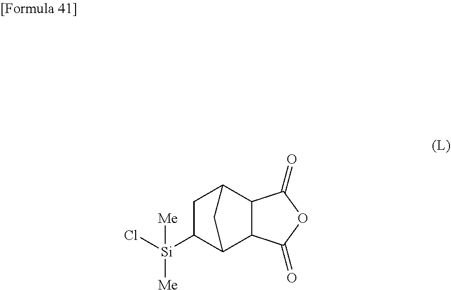 [SMILES: C[Si](C)(Cl)C1CC2CC1C1C(=O)OC(=O)C21]

### Step 3-2: Synthesis of Compound (M)

Trimethylsilanol (0.19 g) and THF (5 mL) were added to a 100 mL three-necked flask under a nitrogen atmosphere, and the mixture was stirred at 25° C. Next, the mixture was cooled to 0° C., and a hexane solution of n-BuLi (1.6M, 0.9 mL) was dropped. Next, a THF solution of hexamethylcyclotrisiloxane (1.2M, 1 mL) was dropped, and a THF solution of hexamethylcyclotrisiloxane (1.2M, 9 mL) was further dropped. Then, the mixture was stirred for 2 hours. Next, the compound (L) (1.28 g) was added, and the mixture was stirred for 1 hour. Hexane and ion-exchanged water were successively added to the reaction solution. Then, the resultant solution was separated, and an organic phase was separated therefrom. The solvent and low-boiling components were removed from the organic phase by distillation under a reduced pressure. Then, 1.2 g of a compound (M) was obtained by performing flash column chromatography (developing solvent: hexane/ethyl acetate) using silica gel. The structure of the compound (M) was confirmed from NMR data shown below. The average value of n in the compound (M) was 18.

¹H-NMR (400 MHz, CDCl₃): δ 3.75 (m, 2H), 3.15 (m, 1H), 2.91 (m, 1H), 2.21-1.50 (m, 5H), 0.06- (−0.10) (m, 129H)

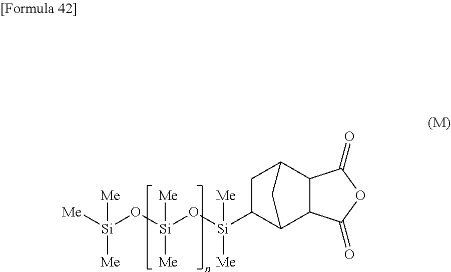

### Step 3-3: Synthesis of Compound (N)

DMF (100 mL), the compound (M) (1.0 g), triethylamine (1.0 g), and 2,2-diallylpenta-4-ene-1-amine (660 mg) were added to a 300 mL flask, and the mixture was heated and refluxed overnight. Hexane and ion-exchanged water were successively added to the reaction solution. Then, the resultant solution was separated, and an organic phase was separated therefrom. The solvent and low-boiling components were removed from the organic phase by distillation under a reduced pressure. Then, 1.0 g of a compound (N) was obtained by performing flash column chromatography (developing solvent: hexane/ethyl acetate) using silica gel. The structure of the compound (N) was confirmed from NMR data shown below. The average value of n in the compound (N) was 18.

¹H-NMR (400 MHz, CDCl₃): δ 5.81 (m, 3H), 5.05-4.85 (m, 6H), 3.75 (m, 2H), 3.35 (m, 2H), 3.15 (m, 1H), 2.91 (m, 1H), 2.21-1.50 (m, 5H), 0.06- (−0.10) (m, 129H).

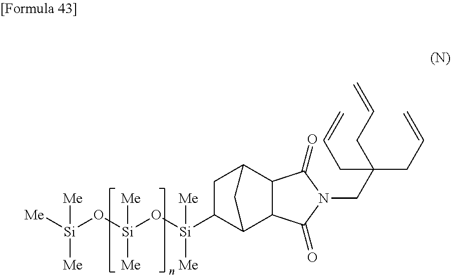

### Step 3-4: Synthesis of Compound (0)

Dichloromethane (10 g) and the compound (N) (0.80 g) were added to a 100 mL flask, and the mixture was stirred at 25° C. Next, a toluene solution of platinum/1,3-divinyl-1,1,3,3-tetramethyldisiloxane complex (platinum content: 3 mass %, 4.1 mg), aniline (2.6 mg), and trimethoxysilane (0.40 g) were added, and the mixture was stirred at 25° C. for 2 hours. 0.77 g of a compound (O) was obtained by removing the solvent from the reaction solution by distillation under a reduced pressure. The structure of the compound (O) was confirmed from NMR data shown below. The average value of n in the compound (O) was 18.

¹H-NMR (400 MHz, CDCl₃): δ 3.75 (m, 2H), 3.40 (s, 27H), 3.35 (m, 2H), 3.15 (m, 1H), 2.91 (m, 1H), 2.21-1.25 (m, 14H), 0.40 (m, 6H), 0.06- (−0.10) (m, 129H).

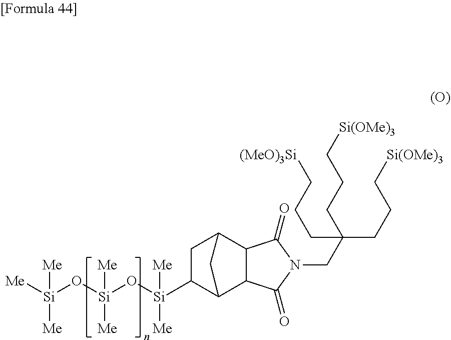

### Example 4: Compound (R)

### Step 4-1: Synthesis of Compound (P)

5.0 g of a compound (P) was obtained in a manner similar to Step 2-1 of Example 2, except that 3-oxo-5β-cholanic acid (5.2 g) was used as a raw material instead of 3-hydroxy-4-adamantane carboxylic acid. The structure of the compound (P) was confirmed from NMR data shown below.

¹H-NMR (400 MHz, CDCl₃): δ 7.42-7.29 (m, 5H), 5.11 (d, J=2.6 Hz, 2H), 2.51 (t, J=13.5 Hz, 1H), 2.40 (ddd, J=15.1, 10.0, 5.0 Hz, 1H), 2.27 (ddd, J=15.6, 9.4, 6.7 Hz, 1H), 2.15-1.92 (m, 3H), 1.92-1.74 (m, 4H), 1.52-0.94 (m, 19H), 0.94-0.84 (m, 8H).

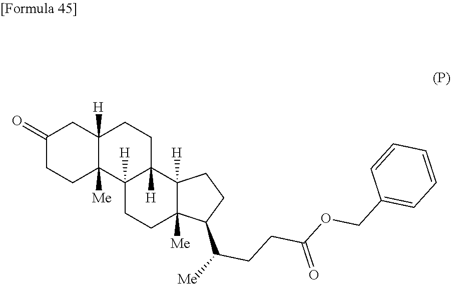

### Step 4-2: Synthesis of Compound (Q)

Methyltriphenylphosphonium bromide (7.8 g) and THF (100 mL) were added to a 300 mL flask, and the mixture was cooled to −78° C. A hexane solution of n-BuLi (33 mL, 1.6M) was added. Then, the temperature of the mixture was raised to 0° C., and the mixture was stirred for 1 hour. The resultant solution was cooled again to −78° C. Then, a tetrahydrofuran solution of the compound (P) (3.4 g) (90 mL) was added, and the mixture was stirred at 0° C. for 12 hours. An aqueous ammonium chloride solution and diethyl ether were successively added to the reaction solution. Then, the resultant solution was separated, and an organic phase was separated therefrom. The organic phase was washed with saturated brine, dried with anhydrous sodium sulfate. Then, 2.2 g of a compound (Q) was obtained by performing flash column chromatography (developing solvent: hexane/ethyl acetate) using silica gel. The structure of the compound (Q) was confirmed from NMR data shown below.

¹H-NMR (400 MHz, CDCl₃): δ 7.42-7.29 (m, 5H), 5.11 (d, J=2.6 Hz, 2H), 4.64-4.49 (m, 2H), 2.51 (t, J=13.5 Hz, 1H), 2.40 (ddd, J=15.1, 10.0, 5.0 Hz, 1H), 2.27 (ddd, J=15.6, 9.4, 6.7 Hz, 1H), 2.15-1.92 (m, 3H), 1.92-1.74 (m, 4H), 1.52-0.94 (m, 19H), 0.94-0.84 (m, 8H).

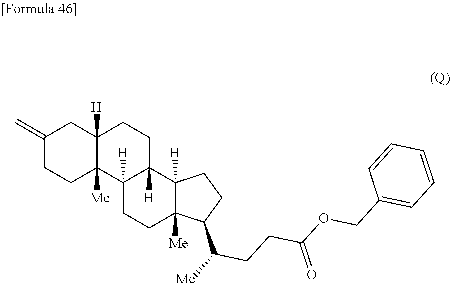

### Step 4-3: Synthesis of Compound (R)

0.8 g of Compound (R) was obtained in a manner similar to Steps 2-3 to 2-7 of Example 2, except that the compound (Q) was used instead of the compound (F). The structure of the compound (R) was confirmed from NMR data shown below. The average value of n in the compound (R) was 18.

¹H-NMR (400 MHz, CDCl₃): δ 3.40 (s, 27H), 3.35 (m, 2H), 2.40 (ddd, J=15.1, 10.0, 5.0 Hz, 1H), 2.27 (ddd, J=15.5, 9.3, 6.6 Hz, 1H), 1.93 (d, J=10.7 Hz, 1H), 1.83 (dd, J=10.8, 6.6 Hz, 3H), 1.73 (d, J=13.1 Hz, 1H), 1.60-0.79 (m, 95H), 0.42 (m, 2H), 0.40 (m, 6H), 0.22- (−0.24) (m, 129H).

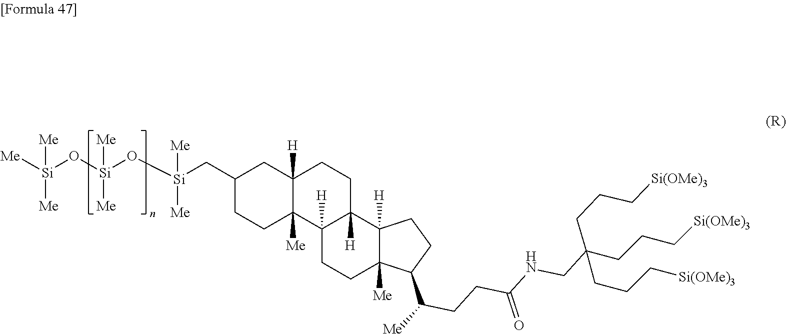

### Example 5: Compound (S)

A compound (S) shown below was synthesized with reference to Example 1 disclosed in International Patent Publication No. WO2023/017830. “18” in the below-shown compound (S) means that the average value of repetitive units represented by [—Si(Me)₂O—] was 18.

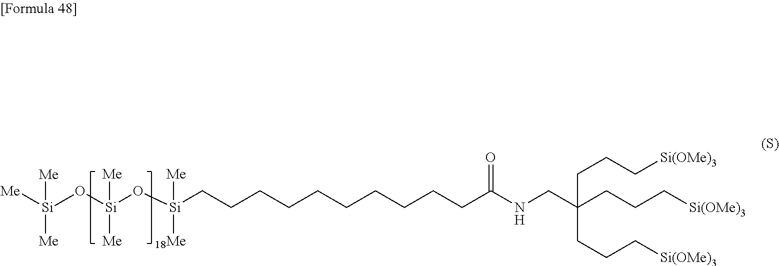

### [Manufacturing of Article]

Articles according to Examples 101 to 105, each of which had a substrate and a surface-treated layer formed on the substrate, were manufactured by performing surface treatments on the substrates using the compounds synthesized in Examples 1 to 5, respectively, by a method described hereinafter. A wet-coating method was used as the surface treatment method.

30 g of silicon oxide was disposed as a vapor-deposition source on a copper hearth in a vacuum vapor-deposition apparatus (“VTR-350M” manufactured by ULVAC KIKO, Inc.). A glass substrate was disposed in the vacuum vapor-deposition apparatus, and the vacuum vapor-deposition apparatus was evacuated of air so that the pressure inside the apparatus became 5×10⁻³ Pa or lower. A substrate including a silicon oxide layer having a thickness of about 20 nm was manufactured by heating the aforementioned hearth to about 2,000° C. and thereby vacuum-depositing silicon oxide on the surface of the substrate.

The substrate including the silicon oxide layer was placed on the sample stage of a spray coater (“API-90RS manufactured by APEIROS) in such a manner that the silicon oxide layer faces upward. Next, 13 g of a heptane solution comprising 0.2 mass % of the compound obtained in each of Examples was charged into the syringe of the spray coater and was sprayed and applied at an atomization pressure of 130 kPa, a distance between the nozzle and the sample surface of 50 mm, and a scanning speed of 300 mm/see (wet-coating method). After that, the substrate including silicon oxide layer, of which the compound had been applied to the surface, was heat-treated at 140° C. for 30 minutes. As a result, for each of Examples 101 to 105, an evaluation sample (article), in which the substrate, the silicon oxide layer, and the surface layer were laminated in this order, was obtained.

### [Evaluations]

The articles of Examples 101 to 105 obtained by the wet-coating method were evaluated for their light stability. The evaluation methods were as follows.

### <Light Stability>

About 2 μL of distilled water was dropped on the surface-treated layer of the article, and the initial water contact angle was measured by using a contact angle measuring apparatus (product name: DM-500 manufactured by Kyowa Interface Science Co., Ltd). Water contact angles were measured at five points on the surface-treated layer, and an arithmetic average value of the measurement values at these points was defined as the initial water contact angle. Note that a 2θ method was used for the measurement of the water contact angle.

A uniform light irradiation unit (manufactured by Ushio Inc.) was attached to a mercury lamp (“SP-9250DB” manufactured by Ushio Inc.), and a sample was placed at a distance of 17.5 cm from the lens in such a manner that the surface-treated layer was opposed to the mercury lamp. Light intensity at 200 to 800 nm, which was measured by using an intensity meter (VEGA manufactured by OPHIL), was 200 mW/cm². The sample was irradiated with uniform light emitted from the mercury lamp for 100 hours in the atmosphere having a temperature of 20 to 40° C. and a humidity of 30 to 75%.

The water contact angle of the sample after the irradiation was measured by a method similar to that for the initial contact angle, and an arithmetic average value calculated from measurement values was defined as the water contact angle after the light irradiation. A difference between the water contact angles before and after the irradiation (degree of decrease) was calculated by the below-shown calculation formula, and the light stability of the surface-treated layer was evaluated based on the calculated difference between the water contact angles before and after the irradiation. The smaller the difference between the water contact angles before and after the irradiation is, the more excellent the light stability is.

$$Difference between water contact angles before and after irradiation = ( Initial contact angle ) - ( Water contact angle after light irradiation )$$

The evaluation criteria of the light stability were as follows.
A: The difference between the water contact angles before and after the irradiation is smaller than 5°.
B: The difference between the water contact angles before and after the irradiation is 5° or larger and is smaller than 10°.
C: The difference between the water contact angles before and after the irradiation is 10° or larger.

Evaluation results are shown in Table 1.

Examples 1 to 4 and 101 to 104 are examples according to the present disclosure, and Examples 5 and 105 are comparative examples.

In the table, in Column “Alicyclic structure” of “Compound”, alicyclic structures of compounds synthesized in the respective examples are shown. Note that “Condensed ring A” means “4-azatricyclo [5.2.1.0^{2,6}] decane ring”, and “Condensed ring B” means “hexadecahydro-1H-cyclopenta [a]phenanthrene ring”. Further, since the compound (S) synthesized in Example 5 did not have an alicyclic structure, “None” is shown in Column “Alicyclic structure”.

TABLE 1

| | | | | | | |
|---|---|---|---|---|---|---|
| Compound | Example | 1 | 2 | 3 | 4 | 5 |
| | Number | (D) | (K) | (O) | (R) | (S) |
| | Alicyclic | Cyclopentane | Adamantane | Condensed | Condensed | None |
| | structure | ring | ring | ring A | ring B | |
| Article | Example | 101 | 102 | 103 | 104 | 105 |

| | | | | | |
|---|---|---|---|---|---|
| Evaluation of light stability | B | A | B | A | C |

As shown in Table 1, it has been found that each of the compounds according to Examples 1 to 4 were capable of forming a surface-treated layer having excellent light stability as compared to the compound according to Example 5.

A compound according to the present disclosure is useful as a surface treatment agent. Such a surface treatment agent can be used, for example, for substrates in display devices such as touch panel displays, optical elements, semiconductor elements, building materials, automobile components, and nanoimprinting technologies. Further, such a surface treatment agent can be used for bodies, window glasses (front glasses, side glasses, and rear glasses), mirrors, bumpers, and the like in transportation apparatuses such as trains, automobiles, ships, and airplanes. Further, such a surface treatment agent can be used for exterior walls of buildings, tents, photovoltaic modules, sound insulating plates, and outdoor articles such as concrete; and fishing nets, sweep nets, and water tanks. Further, such a surface treatment agent can be used for kitchens, bathrooms, washstands, mirrors, and toiletry components; chandeliers and ceramics such as tiles; and artificial marble and various indoor apparatuses such as air conditioners. Further, such a surface treatment agent can be used for antifouling treatments of jigs, inner walls, pipes, and the like in factories. Further, such a surface treatment agent can be used for goggles, glasses, helmets, pachinko, fibers, umbrellas, play equipment, and soccer balls. Further, such a surface treatment agent can be used as abherents for various packaging materials such as packaging materials for foods, packaging materials for cosmetics, and the interior of pots. Further, such a surface treatment agent can be used for car navigation systems, mobile phones, smart phones, digital cameras, digital video cameras, PDAs, portable audio players, car audios, game apparatuses, lenses for eyeglasses, camera lenses, lens filters, sunglasses, medical apparatuses such as gastroscopes, copy machines, PCs, displays (e.g., liquid crystal displays, organic EL displays, plasma displays, and touch panel displays), touch panels, protective films, and optical components such as antireflection films.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A compound represented by Formula (1-1) or Formula (1-2) 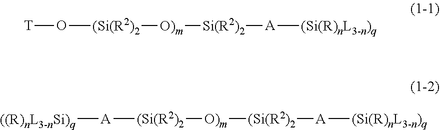
wherein
T is (R¹)₃Si—, a monovalent cyclic polysiloxane residue, or a monovalent cage-like polysiloxane residue,
R¹ is each independently a hydrocarbon group or a trialkylsilyloxy group,
R² is each independently a hydrocarbon group or a trialkylsilyloxy group,
A is each independently a linking group having a valence of (q+1) and having an alicyclic structure which may have a heteroatom,
R is each independently a hydrocarbon group,
L is each independently a hydrolyzable group, a group having a hydrolyzable group, or a hydroxyl group,
m is a number of 0 or greater,
n is each independently an integer of 0 to 2, and
q is each independently an integer of 1 or greater.

2. The compound according to claim 1, wherein the compound represented by Formula (1-1) is a compound represented by Formula (2), a compound represented by Formula (3), or a compound represented by Formula (4) 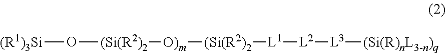
R¹ is each independently a hydrocarbon group or a trialkylsilyloxy group,
R² is each independently a hydrocarbon group or a trialkylsilyloxy group,
L¹ is a single bond or a divalent linking group,
L² is a divalent alicyclic group which may have a heteroatom,
L³ is a linking group having a valence of (q+1),
R is each independently a hydrocarbon group,
L is each independently a hydrolyzable group, a group having a hydrolyzable group, or a hydroxyl group,
m is a number of 0 or greater,
n is each independently an integer of 0 to 2, and
q is an integer of 1 or greater 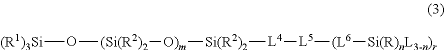
R¹ is each independently a hydrocarbon group or a trialkylsilyloxy group,
R² is each independently a hydrocarbon group or a trialkylsilyloxy group,
L⁴ is a single bond or a divalent linking group,
L⁵ is an alicyclic group which may have a heteroatom having a valence of (r+1),
L⁶ is each independently a single bond or a divalent linking group,
R is each independently a hydrocarbon group,
L is each independently a hydrolyzable group, a group having a hydrolyzable group, or a hydroxyl group,
m is a number of 0 or greater,
n is each independently an integer of 0 to 2, and
r is an integer of 1 or greater, 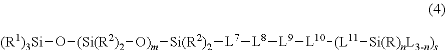
R¹ is each independently a hydrocarbon group or a trialkylsilyloxy group,
R² is each independently a hydrocarbon group or a trialkylsilyloxy group,
L⁷ and L⁹ are each independently a single bond or a divalent linking group,
L⁸ is a divalent alicyclic group which may have a heteroatom,
L¹⁰ is an alicyclic group which may have a heteroatom having a valence of (s+1),
L¹¹ is each independently a single bond or a divalent linking group,
R is each independently a hydrocarbon group,
L is each independently a hydrolyzable group, a group having a hydrolyzable group, or a hydroxyl group,
m is a number of 0 or greater,
n is each independently an integer of 0 to 2, and
s is an integer of 1 or greater.

3. The compound according to claim 1, wherein m is a number of 2 to 600.

4. The compound according to claim 1, wherein q is an integer of 1 to 4.

5. The compound according to claim 2, wherein m is a number of 2 to 600.

6. The compound according to claim 2, wherein q is an integer of 1 to 4.

7. A composition comprising a compound according to claim 1, and a liquid medium.

8. A surface treatment agent comprising a compound according to claim 1.

9. A surface treatment agent comprising a compound according to claim 1, and a liquid medium.

10. A method for manufacturing an article including a surface-treated layer formed on a substrate by performing a surface treatment on the substrate by using the surface treatment agent according to claim 8.

11. An article comprising a substrate, and a surface-treated layer disposed on the substrate, a surface of the surface-treated layer being treated with the surface treatment agent according to claim 8.

12. The article according to claim 11, wherein the article is an optical member.

13. The article according to claim 11, wherein the article is a display or a touch panel.

14. A method for manufacturing an article including a surface-treated layer formed on a substrate by performing a surface treatment on the substrate by using the surface treatment agent according to claim 9.

15. An article comprising a substrate, and a surface-treated layer disposed on the substrate, a surface of the surface-treated layer being treated with the surface treatment agent according to claim 9.

16. The article according to claim 15, wherein the article is an optical member.

17. The article according to claim 15, wherein the article is a display or a touch panel.
